(19) United States
(12) Patent Application Publication
(10) Pub. No.: US 2024/0163549 A1
(43) Pub. Date: May 16, 2024

(54) IMAGING DEVICE, IMAGING METHOD, AND INFORMATION PROCESSING DEVICE

(71) Applicant: Kanta SHIMIZU, Kanagawa (JP)

(72) Inventor: Kanta SHIMIZU, Kanagawa (JP)

(21) Appl. No.: 18/281,777

(22) PCT Filed: Mar. 22, 2022
(86) PCT No.: PCT/JP2022/013038

§ 371 Date: Sep. 13, 2023

(30) Foreign Application Priority Data
Mar. 23, 2021 (JP) 2021-048022
Mar. 23, 2021 (JP) 2021-048028
Mar. 23, 2021 (JP) 2021-048195

(51) Int. Cl. H04N 23/63; G01S 17/86; G01S 17/894; G06T 7/00; G06T 7/13

(52) U.S. Cl. CPC H04N 23/634; G01S 17/86; G01S 17/894; G06T 7/0002; G06T 7/13; G06T 2207/30168

(57) ABSTRACT

An imaging device includes an imaging unit configured to capture an image of an object; a projector configured to project light onto the object; a light receiver configured to receive light reflected from the object; a determination unit configured to determine whether a presence or absence of at least one of a high reflection object, a low reflection object, a distant object, or an image blur, based on both an output of the light receiver and an output of the imaging unit; and a display controller configured to cause a display unit to present a different display according to the presence or absence of at least one of the high reflection object, the low reflection object, the distant object, or the image blur.

### TECHNICAL FIELD

The disclosure discussed herein relates to an imaging device, an imaging method, and an information processing device.

### BACKGROUND ART

Patent Document 1 discloses a ranging apparatus capable of measuring a distance to an object stably and accurately.

Patent Document 2 discloses an imaging device configured to perform image processing to reduce the adverse effect of reflection when the fingers or the like are reflected in the captured image.

Patent Document 3 discloses a three-dimensional synthesis processing system that includes a measurement position display unit. The measurement position display unit extracts blocks in which the density of measurement data is less than a predetermined threshold and presents coordinates within the range of the extracted blocks as a proposed measurement position, at which a three-dimensional measurement device should be installed.

### CITATION LIST

### Patent Literature

[PTL 1] Japanese unexamined patent publication No. 2018-077071
[PTL 2] Japanese Patent No. 5423287
[PTL 3] Japanese Patent No. 619938

### SUMMARY OF INVENTION

### Technical Problem

According to the present disclosure, an imaging device, an imaging method, and an information processing device capable of easily identifying a specific object included in a displayed image are provided.

### Solution to Problem

According to an aspect of embodiments of the present disclosure, an imaging device is provided. The imaging device includes
an imaging unit configured to capture an image of an object;
a projector configured to project light onto the object;
a light receiver configured to receive light reflected from the object;
a determination unit configured to determine whether a presence or absence of at least one of a high reflection object, a low reflection object, a distant object, or an image blur, based on both an output of the light receiver and an output of the imaging unit; and
a display controller configured to cause a display unit to present a different display according to the presence or absence of at least one of the high reflection object, the low reflection object, the distant object, or the image blur.

### Advantageous Effect of the Invention

According to the present disclosure, an imaging device, an imaging method, and an information processing device that can easily identify a specific object contained in a displayed image can be provided.

### BRIEF DESCRIPTION OF DRAWINGS

FIG. 1 is a diagram illustrating an example of an appearance of an imaging device according to an embodiment of the present disclosure.

FIG. 2 is a diagram illustrating a configuration of an imaging device according to the embodiment.

FIG. 3A is a diagram illustrating a state of use of an imaging device according to the embodiment.

FIG. 3B is a diagram illustrating a state of use of an imaging device according to the embodiment.

FIG. 3C is a diagram illustrating a state of use of an imaging device according to the embodiment.

FIG. 3D is a diagram illustrating a state of use of an imaging device according to the embodiment.

FIG. 4 is a diagram illustrating an example of a configuration of a processing block of a processing circuit according to the embodiment.

FIG. 5 is a flowchart illustrating an example of an operation of the processing circuit of the imaging device according to the embodiment.

FIG. 6A is a flowchart illustrating the generation of omnidirectional image data according to the embodiment.

FIG. 6B is a flowchart illustrating the generation of omnidirectional image data according to the embodiment.

FIG. 7 is a flowchart illustrating the determination of a proximate object according to the embodiment.

FIG. 8 is a diagram illustrating display contents of a display unit according to the embodiment.

FIG. 9 is a diagram illustrating an appearance of an imaging device according to a modification of the embodiment.

FIG. 10 is a diagram illustrating a configuration of a processing block of a processing circuit according to the modification.

FIG. 11 is a diagram illustrating an appearance of an imaging device according to a second modification of the embodiment of the present disclosure.

FIG. 12 is a diagram illustrating a configuration of a processing block of a processing circuit according to the second modification.

FIG. 13 is a flowchart illustrating a process of determining a proximate object according to the second modification.

FIG. 14 is a diagram illustrating a configuration of an imaging device according to a third modification of the embodiment of the present disclosure.

FIG. 15 is a flowchart illustrating a process of determining a high reflection object according to the embodiment of the present disclosure.

FIG. 16 is a flowchart illustrating a process of determining a distant object and a low reflection object according to the embodiment.

FIG. 17 is a flowchart illustrating a process of determining the presence or absence of image blur according to the embodiment.

FIG. 18A is a flowchart illustrating a determination process according to a fourth modification of the embodiment of the present disclosure.

FIG. 18B is a flowchart illustrating a determination process according to the fourth modification.

FIG. 18C is a flowchart illustrating a determination process according to the fourth modification.

FIG. 19 is a diagram illustrating an example of a configuration of a processing block of a processing circuit according to a fifth modification of the embodiment of the present disclosure.

FIG. 20 is a diagram illustrating an example of a configuration of an information processing system according to a sixth modification of the embodiment of the present disclosure.

FIG. 21 is a diagram illustrating an example of a configuration of an information processing system according to a seventh modification of the embodiment of the present disclosure.

FIG. 22 is a diagram illustrating display contents of a display unit according to the fifth to seventh modifications.

FIG. 23A is a diagram illustrating a three-dimensional image displayed by a display unit according to the embodiment of the present disclosure.

FIG. 23B is a diagram illustrating a three-dimensional image displayed by the display unit according to the embodiment.

FIG. 23C is a diagram illustrating a three-dimensional image displayed by the display unit according to an embodiment of the present disclosure.

FIG. 24 is a flowchart illustrating a determination process according to the fifth to seventh modifications.

FIG. 25 is another diagram illustrating the display contents of the display unit according to the fifth to seventh modifications.

FIG. 26 is a flowchart illustrating a process according to the fifth to seventh modifications.

FIG. 27 is another flowchart illustrating a process according to the fifth to seventh modifications.

### DESCRIPTION OF EMBODIMENTS

Hereinafter, embodiments of an imaging device, an imaging method, and an information processing device will be described in detail with reference to the accompanying drawings.

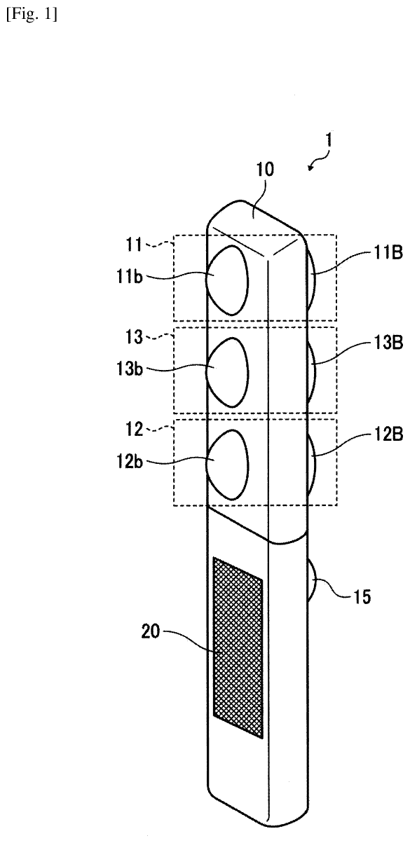

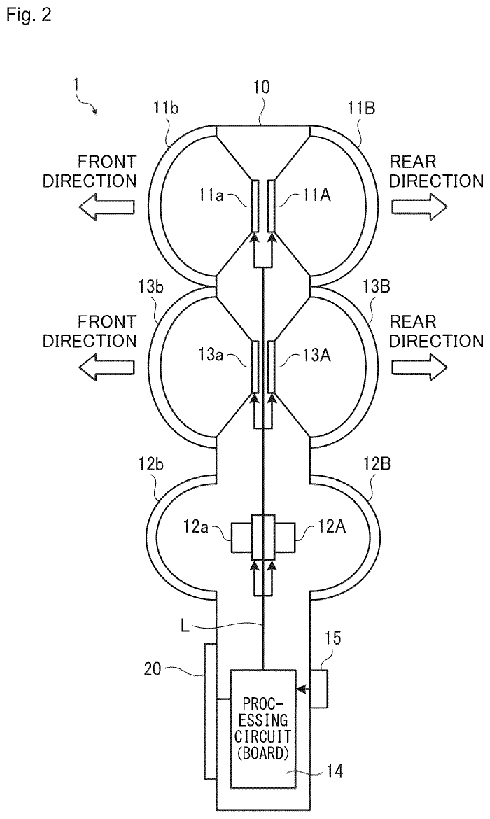

FIG. 1 is a diagram illustrating an example of the appearance of an imaging device according to an embodiment of the present disclosure. FIG. 2 is a diagram illustrating a configuration of the imaging device. FIG. 2 illustrates an internal configuration of the imaging device of FIG. 1.

The imaging device 1 is an example of an information processing device configured to output three-dimensional information, that is determined on the basis of received light. An imaging unit (camera) 11, a projector (part corresponding to a light emitter of a distance sensor) 12 configured to project light other than visible light, and a distance information acquiring unit (part corresponding to a light receiver of the distance sensor) 13 configured to acquire distance information based on the light projected by the projector 12 are integrally provided with respect to the housing 10. Each of the units is electrically connected to a processing circuit 14 inside the housing 10 by a synchronization signal line L, and operates in synchronization with each other.

A shooting switch 15 is used by a user to input a shooting instruction signal to the processing circuit 14. A display unit 20 displays contents corresponding to an output signal of the processing circuit 14, and is formed by a liquid crystal display or the like. The display unit 20 is formed by a touch panel or the like and may receive an operation input from a user. Based on the shooting instruction, the processing circuit 14 controls each unit and acquires data of RGB image and distance information, and reconstructs the acquired distance information data into high-density three-dimensional point cloud data, based on data of the RGB image and the distance information.

Although it is possible to construct the three-dimensional point cloud data even if the distance information data is used as it is, in this case, the accuracy of the three-dimensional point cloud data is limited to the number of pixels (resolution) of the distance information acquiring unit 13. This example also illustrates a process when the three-dimensional point cloud data is reconstructed into high-density three-dimensional point cloud data. The reconstructed data is output to an external PC through a portable recording medium or communication, and is used to display a three-dimensional reconstruction model.

Each unit and the processing circuit 14 are supplied with power from a battery contained within the housing 10. Alternatively, the power may be supplied by a connection cord outside of the housing 10.

The imaging unit 11 captures two-dimensional image information, and includes image sensor elements 11a and 11A, fisheye lenses (wide-angle lenses) 11b and 11B, and the like. The projector 12 includes light source units 12a and 12A, wide-angle lenses 12b and 12B, and the like. The distance information acquiring unit 13 includes TOF (Time of Flight) sensors 13a and 13A, wide-angle lenses 13b and 13B, and the like. Although not illustrated, each unit may include an optical system such as a prism or a lens group.

For example, the imaging unit 11 may include an optical system to image light collected by the fisheye lenses 11b and 11B into the image sensor elements 11a and 11A. In addition, the projector 12 may include an optical system to direct light from the light source units 12a and 12A to the wide-angle lenses 12b and 12B. In addition, the distance information acquiring unit 13 may include an optical system to image light collected by the wide-angle lenses 13b and 13B into the TOF sensors 13a and 13A. Each optical system may be appropriately determined according to the configurations and arrangements of the image sensor elements 11a and 11A, the light source units 12a and 12A, and the TOF sensors 13a and 13A. In this example, illustration of an optical system, such as a prism or a lens group, will be omitted.

The image sensor elements 11a and 11A, the light source units 12a and 12A, and the TOF sensors 13a and 13A are integrally housed within the housing 10. A fisheye lens 11b, the wide-angle lens 12b, the wide-angle lens 13b, and the display unit 20 are disposed on a first surface of the housing 10 at the front side. In the first surface, the respective inner ranges of the fisheye lens 11b, wide-angle lens 12b, and wide-angle lens 13b are open.

The fisheye lens 11B, a wide-angle lens 12B, a wide-angle lens 13B, and a shooting switch 15 are disposed on a second surface of the housing 10 at the rear side. In a second plane, the respective inner ranges of fisheye lens 11B, wide-angle lens 12B, and wide-angle lens 13B are open.

The image sensor elements 11a and 11A are image sensors (area sensors) with two-dimensional resolution. The image sensor elements 11a and 11A have an imaging area in which a plurality of light receiving elements (photodiodes) of respective pixels are arranged in a two-dimensional direction. The imaging area is provided with R (Red), G (Green), and B (Blue) color filters, such as a Bayer array, to receive visible light, and light passing through the color filters is stored in the photodiodes. Here, an image sensor having a large number of pixels can be used to acquire a two-dimensional image of a wide angle (e.g., a hemispheric range of 180 degrees in circumference with the imaging direction facing the front as illustrated in FIG. 2) at a high resolution.

The image sensor elements 11a and 11A convert the light captured in the imaging area into an electrical signal by pixel circuitry of each pixel to output a high resolution RGB image. The fisheye lenses 11b and 11B collect light from a wide angle (e.g., a hemispheric range of 180 degrees in circumference with the imaging direction facing the front as illustrated in FIG. 2) and image the light into the imaging areas of the image sensor elements 11a and 11A.

The light source units 12a and 12A are semiconductor lasers that emit laser light in a wavelength band other than the visible light region (here, for example, infrared) used for measuring distance. One semiconductor laser may be used for the light source units 12a and 12A, or a plurality of semiconductor lasers may be used in combination. A surface emitting laser, such as VCSEL (Vertical Cavity Surface Emitting LASER), may also be used as a semiconductor laser.

Alternatively, the light from the semiconductor laser can be shaped to be vertically longer by an optical lens, and the vertically lengthened light can be scanned in the one-dimensional direction of the measurement area by optical deflectors such as Micro Electro Mechanical Systems (MEMS) mirrors. In the present embodiment, as the light source units 12a and 12A, the light of the semiconductor laser LA is spread over a wide-angle range through the wide-angle lenses 12b and 12B without using the optical deflectors such as a MEMS mirror.

The wide-angle lenses 12b and 12B of the light source units 12a and 12A function to expand the light emitted by the light source units 12a and 12A to a wide-angle range (e.g., a hemispheric range of 180 degrees in circumference with the imaging direction facing the front as illustrated in FIG. 2).

The wide-angle lenses 13b and 13B of the distance information acquiring unit 13 capture reflection of light from the light source units 12a and 12A projected by the projector 12 from each direction of the wide-angle light of a measurement range (e.g., a hemispheric range of 180 degrees in circumference with the imaging direction facing the front as illustrated in FIG. 2) and image the light in the light receiving area of the TOF sensors 13a and 13A. The measuring range encompasses one or more projection objects (e.g., a building), and light (reflected light) reflected by the projection objects enters wide-angle lenses 13b and 13B. The reflected light may be captured, for example, by providing a filter across the surfaces of the wide-angle lenses 13b and 13B that cuts off light of wavelengths in the infrared region or greater. Note that the invention is not limited thereto; since the light in the infrared region may enter the light receiving area, a unit configured to pass light in the infrared region, such as a filter, through the optical path from the wide-angle lens 13b and 13B to the light receiving area may be provided.

The TOF sensors 13a and 13A are two-dimensional resolution optical sensors. The TOF sensors 13a and 13A have a light receiving area in which a number of light receiving elements (photodiodes) are arranged in a two-dimensional direction. In this sense, the TOF sensors 13a and 13A may be referred to as a “second imaging light receiver”. The TOF sensors 13a and 13A receive the reflected light in each area within a measuring range (each area may also be referred to as a position) by the light receiving element associated with the corresponding area and measure (calculate) the distance to each area based on the light detected by the corresponding light receiving element.

In this embodiment, the distance is measured by a phase difference detection method. In the phase difference detection method, laser light modulated with amplitude at the fundamental frequency is applied in the measurement range, the time is obtained by measuring the phase difference between the applied light and the reflected light, and the distance is calculated by multiplying the time by the speed of light. The advantage of this method is that a certain degree of resolution can be expected.

The TOF sensors 13a and 13A are driven in synchronization with the light irradiation by the projector 12, and each of the light receiving elements (corresponding to a pixel) calculates the distance corresponding to each pixel from the phase difference between the reflected light and the light, and outputs the distance information image data (also called “distance image” or “TOF image” later) that maps the information indicating the distance to each area in the measurement range to the pixel information. The TOF sensors 13a and 13A may output phase information image data that maps phase information to pixel information, and obtain distance information image data based on the phase information image data in post-processing.

The number of areas into which the measurement range can be divided is determined by the resolution of the light receiving area. Accordingly, if a lower resolution is used for miniaturization, the number of pixel information in the distance image data is reduced, and thus the number of three-dimensional point clouds is also reduced.

Alternatively, the distance may be measured by a pulse method instead of a phase difference detection method. In this case, for example, the light source units 12a and 12A emit an irradiation pulse P1 of an ultra-short pulse with a rise time of a few nanoseconds (ns) and a high light peak power, and the TOF sensors 13a and 13A measure, in synchronization with the light source units 12a and 12A, the time (t) taken until the reflected pulse P2, which is the reflected light of the irradiation pulse P1 emitted by the light source units 12a and 12A, is received.

When this method is used, for example, as the TOF sensors 13a and 13A, a circuit that measures time is installed on the output side of the light receiving element. In each circuit, for each light receiving element, the time taken from the time the light source units 12a and 12a emit the irradiation pulse P1 to the time the reflection pulse P2 is received is converted into a distance to obtain the distance to each area.

This method is suitable for broadening the angle of the imaging device 1 because the peak light can be used to output intense light. In addition, if the light is configured to be oscillated (scanned) using MEMS mirrors, etc., the powerful light can be emitted farther while reducing its spread, leading to an increase in the measurement distance. In this case, the laser light emitted from the light source units 12a and 12A is arranged to be scanned (deflected) by the MEMS mirrors toward the wide-angle lenses 12b and 12B.

It is preferable that the effective image angle of the imaging unit 11 and the effective image angle of the distance information acquiring unit 13 are equal to each other at, for example, 180 degrees or more, but the effective image angle of the imaging unit 11 and the effective image angle of the distance information acquiring unit 13 are not necessarily required to be equal to each other. The effective image angle of the imaging unit 11 and the effective image angle of the distance information acquiring unit 13 may be reduced, as required. According to the present embodiment, the imaging unit 11 and the distance information acquiring unit 13 reduce the effective pixels to be within a range of, for example, 100 degrees to 180 degrees so that the imaging device 1 body and the distance information acquiring unit 13 are not included in the field angle.

The resolution of the TOF sensors 13a and 13A may be set to be less than the resolution of the image sensor elements 11a and 11A with priority given to the miniaturization of the imaging device 1. Since the TOF sensors 13a and 13A have a lower resolution than the image sensor elements 11a and 11A, the size of the light receiving area can be reduced, and thus the size of the imaging device 1 can be reduced. Hence, the TOF sensors 13a and 13A have a low resolution, and the three-dimensional point cloud obtained by the TOF sensors 13a and 13A have a low density. However, since the processing circuit 14 that is an “acquiring unit” is provided, the three-dimensional point cloud obtained by the TOF sensors 13a and 13A can be converted into a high-density three-dimensional point cloud. The process of converting a low-density three-dimensional point cloud into a high-density three-dimensional point cloud in the processing circuit 14 will be described later.

In this embodiment, for example, the image sensor element 11a, the light source unit 12a, and the TOF sensor 13a are linearly arranged in the longitudinal direction of the housing 10. Similarly, the image sensor element 11A, the light source unit 12A, and the TOF sensor 13A are linearly arranged in the longitudinal direction of the housing 10. Hereinafter, an example of the image sensor element 11a, the light source unit 12a, and the TOF sensor 13a will be described.

The imaging area (imaging surface) of the image sensor element 11a or the light receiving area (light receiving surface) of the TOF sensor 13a may be disposed in a direction perpendicular to the longitudinal direction as illustrated in FIG. 2, or may be disposed in a longitudinal direction by providing a prism or the like that converts the straight direction (optical path) of the incident light by 90 degrees. Alternatively, the imaging area (imaging surface) of the image sensor element 11a or the light receiving area (light receiving surface) of the TOF sensor 13a may be arranged in any orientation according to the configuration. That is, the image sensor element 11a, the light source unit 12a, and the TOF sensor 13a are arranged to cover the same measurement range. The imaging unit 11, the projector 12, and the distance information acquiring unit 13 are disposed from the one side of the housing 10 toward the measurement range.

In this case, it is sufficient that the image sensor element 11a and the TOF sensor 13a can be disposed on the same baseline in a parallel stereo manner. Even if only one image sensor element 11a is disposed, the output of the TOF sensor 13a can be used to obtain parallax data by arranging the image sensor element 11a in a parallel stereo manner. The light source unit 12a is configured so that light can be applied into the measuring range of the TOF sensor 13a.

Processing Circuit

Next, a process of the processing circuit 14 will be described. The TOF image obtained by only the TOF sensors 13a and 13A has a low resolution. Accordingly, the present embodiment illustrates an example in which the resolution is enhanced by the processing circuit 14 such that the high-density three-dimensional point cloud data is reconstructed. Some or all of the following processes as an “information processing unit” in the processing circuit 14 may be performed by an external device.

As described above, the three-dimensional point cloud data reconstructed by the imaging device 1 is output to an external device such as a PC through a portable recording medium or communication, and is used to display a three-dimensional reconstruction model.

Accordingly, compared to the case where the imaging device 1 itself displays a three-dimensional reconstruction model, it is possible to provide the imaging device 1 with excellent portability, an increased speed, a reduced size, and a reduced weight.

However, after the three-dimensional information is restored by an external device located away from the site where the three-dimensional information is acquired, a photographer (or a user) may notice that the photographer himself/herself or his/her tripod has been reflected in the captured image or that the three-dimensional information of a desired layout has not been acquired. In such a case, it takes time to revisit the site where the three-dimensional information is acquired again.

To solve such a problem, it is conceivable to bring an external device such as a PC to the site, but in such a case, the advantages of higher speed, smaller size, and lighter weight will be eliminated.

In addition, it is also conceivable to transmit the acquired three-dimensional information to an external device through a communication line and receive the restored three-dimensional information. However, it is difficult to visually identify the reflection of the acquired three-dimensional information on the captured image, such as a photographer himself or a tripod, because the amount of information is large in the first place.

Especially, in the case of omnidirectional three-dimensional information, it is extremely difficult to visually identify that a photographer himself or his/her tripod is reflected in the captured image.

In view of the foregoing problems, the present embodiment is intended to provide an imaging device 1 that can easily identify in real time that a photographer himself/herself, a tripod, or the like is reflected in the captured image or that desired three-dimensional information of a layout has not been acquired.

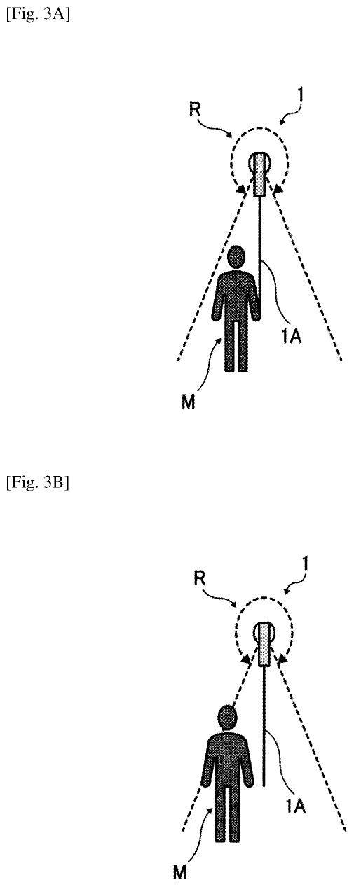

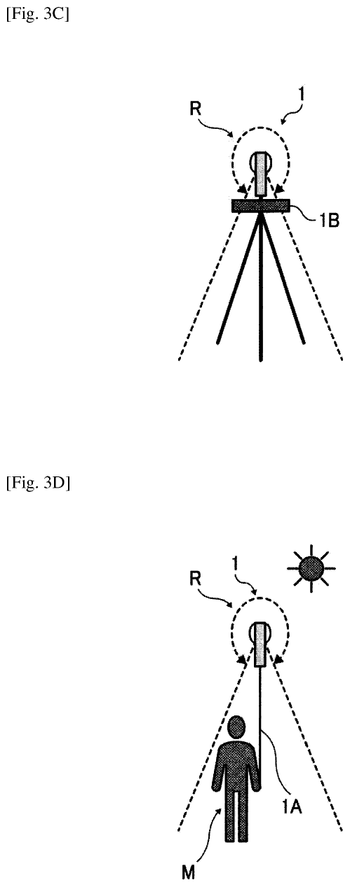

FIGS. 3A to 3D are diagrams each illustrating a state of use of an imaging device according to the embodiment.

In the state illustrated in FIG. 3A, a photographer M and a selfie stick 1A supporting the imaging device 1 are not included in an omnidirectional imaging range R, and the photographer M and the selfie stick 1A are not reflected in the omnidirectionally captured image.

In the state illustrated in FIG. 3B, the photographer M is included in the universe imaging range R, and the photographer M is reflected in the omnidirectionally captured image.

In the state illustrated in FIG. 3C, tripod 1B supporting imaging device 1 is included in an omnidirectional imaging range R and tripod 1B is reflected in the omnidirectionally captured image.

In the state illustrated in FIG. 3D, the photographer M and the selfie stick 1A supporting the imaging device 1 are not included in the omnidirectional imaging range R, and the photographer M and the selfie stick 1A are not reflected in the omnidirectionally captured image; however, since external light (e.g., sunlight, illumination, etc.) is strong, the photographer M and the selfie stick 1A appearing reflected in the captured image may be wrongly determined.

Further, in the states illustrated in FIGS. 3B and 3C, since the colors and types of objects reflected in the captured image and the way these objects appear vary, it seems difficult to uniformly determine whether or not an object was reflected in the captured image.

In response to the above-described states, when determining the presence or absence of a specific object (proximate object) such as a photographer or a tripod based on the distance information image data output from the TOF sensors 13a and 13A, it is difficult to distinguish whether a specific object is actually present or external light is simply too strong.

That is, when the charged amounts of the specific pixels of the TOF sensors 13a and 13A are saturated, it is difficult to distinguish, as a cause of the saturation, whether a specific object is present, or the external light intensity is too strong, based only on the output of the TOF sensors 13a and 13A.

In view of the foregoing problems, another object of the present embodiment is to provide an imaging device 1 which is capable of accurately identifying whether or not a specific object, such as a photographer himself/herself or his/her tripod, is reflected in the captured image, in distinction from the effect of external light. The present embodiment is also intended to check that a proximate object as well as objects such as a high reflection object, a distant object and a low reflection object, and an image blur, and the like are included in the captured image.

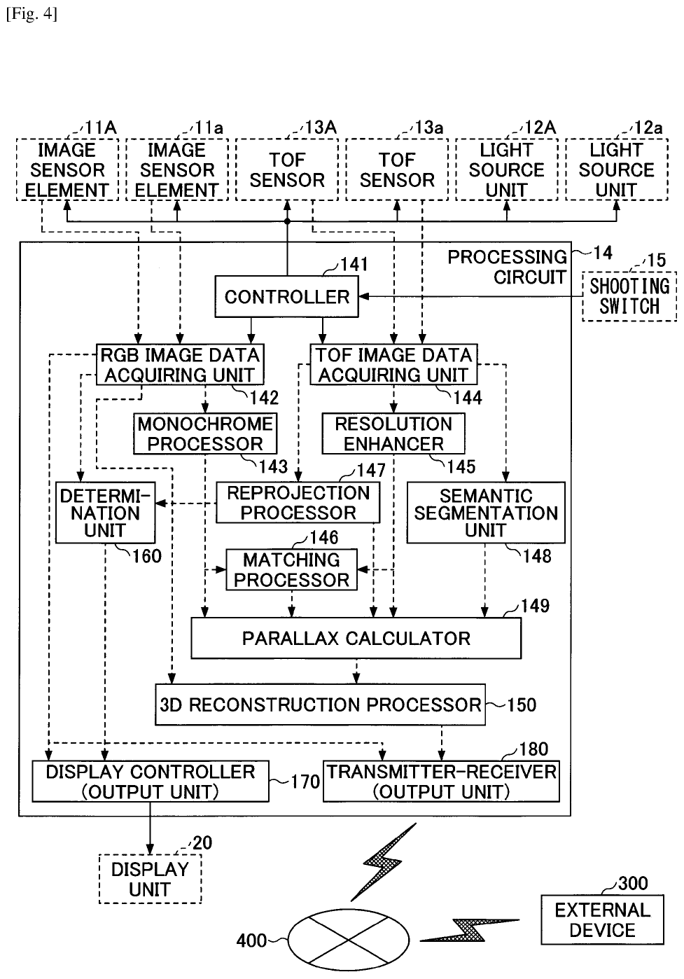

FIG. 4 is a diagram illustrating an example of a configuration of a processing block of the processing circuit 14. The processing circuit 14 illustrated in FIG. 4 includes a controller 141, an RGB image data acquiring unit 142, a monochrome processor 143, a TOF image data acquiring unit 144, a resolution enhancer 145, a matching processor 146, a reprojection processor 147, a semantic segmentation unit 148, a parallax calculator 149, a three-dimensional reconstruction processor 150, a determination unit 160, a display controller 170 as an example of an output unit, and a transmitter-receiver 180 as an example of an output unit. In FIG. 4, a solid arrow indicates a signal flow, and a broken arrow indicates a data flow.

In response to receiving an ON signal (shooting start signal) from the shooting switch 15, the controller 141 outputs synchronization signals to the image sensor elements 11a and 11A, the light source units 12a and 12A, and the TOF sensors 13a and 13A, and controls the entire processing circuit 14. The controller 141 first outputs a signal instructing the output of ultra-short pulses to the light source units 12a and 12A, and outputs a signal instructing the generation of TOF image data to the TOF sensors 13a and 13A at the same timing. The controller 141 outputs a signal instructing imaging to the image sensor elements 11a and 11A. It should be noted that the imaging in the image sensor elements 11a and 11A may be performed during a period when the light source units 12a and 12A are emitting light or during a period immediately before or after light is emitted from the light source units 12a and 12A.

The RGB image data acquiring unit 142 acquires RGB image data captured by the image sensor elements 11a and 11A and outputs omnidirectional RGB image data based on an image capturing instruction by the controller 141. The monochrome processor 143 performs a process of gathering data species in order to perform a matching process with the TOF image data obtained from the TOF sensors 13a and 13A. In this example, the monochrome processor 143 performs a process of converting the omnidirectional RGB image data into an omnidirectional monochrome image.

The TOF image data acquiring unit 144 acquires the TOF image data generated by the TOF sensors 13a and 13A based on the instruction for generating the TOF image data by the controller 141 and outputs omnidirectional TOF image data.

The resolution enhancer 145 assumes the omnidirectional TOF image data as a monochrome image and enhances its resolution. Specifically, the resolution enhancer 145 replaces a value of the distance corresponding to each pixel of the omnidirectional TOF image data with the value of the omnidirectional monochrome image (gray scale value). The resolution enhancer 145 further increases the resolution of the omnidirectional monochrome image up to the resolution of the omnidirectional RGB image data obtained from the image sensor elements 11a and 11A. Conversion to high resolution is performed, for example, by performing a normal upconversion process. As another conversion method, for example, consecutively generated omnidirectional TOF image data may be acquired in multiple frames, which are used to perform a super-resolution process by adding the distance of adjacent points.

The matching processor 146 extracts a feature amount of a portion of texture for the omnidirectional monochrome image obtained by enhancing a resolution of the omnidirectional TOF image data and a feature amount of a portion of texture for a monochrome image of the omnidirectional RGB image data, and performs a matching process based on the extracted feature amounts. For example, the matching processor 146 extracts an edge from each monochrome image and performs the matching process between the extracted edge information. Alternatively, the matching process may be performed using a feature-based method of texture modification such as SIFT. Here, the matching process indicates search for corresponding pixels.

A specific method of the matching process is, for example, block matching. Block matching is a method of calculating the similarity between a pixel value that is cut out as a block of M×M (M is a positive integer) pixel size around the referenced pixel and a pixel value that is cut out as a block of M×M pixels around the pixel that is the center of the search in the other image, and using the central pixel that has the highest similarity as the corresponding pixel.

Similarity is calculated in different ways. For example, an expression representing the Normalized Correlation Coefficient (NCC) (Normalized Correlation Coefficient) may be used. The normalized correlation coefficient CNCC indicates that the higher the value, the higher the similarity, and if the pixel values of the blocks are fully matched, 1 is presented.

Since data on the distance of texture-less areas can also be obtained from the omnidirectional TOF image data, the matching process can be weighted according to the areas. For example, in the calculation of an expression representing CNCC, weights may be applied to areas other than edges (texture-less areas).

Alternatively, instead of the expression representing NCC, a selective Correlation Coefficient (SCC) or the like may be used.

The reprojection processor 147 performs a process of reprojecting the omnidirectional TOF image data representing the distance of each position (area) of the measurement range to the two-dimensional coordinates (screen coordinate system) of the imaging unit 11. Reprojection indicates finding the coordinates at which the three-dimensional points calculated by the TOF sensors 13a and 13A appear in the images in the image sensor elements 11a and 11A. The omnidirectional TOF image data illustrates the position of a three-dimensional point in the coordinate system centered on the distance information acquiring unit 13 (mainly wide-angle lenses 13b and 13B). Thus, the three-dimensional point represented by the omnidirectional TOF image data is re-projected to the coordinate system centered on the imaging unit 11 (mainly the fisheye lenses 11b and 11B).

For example, the reprojection processor 147 translates the coordinates of the three-dimensional points of the omnidirectional TOF image data into the coordinates of the three-dimensional points centered on the imaging unit 11, and performs a process of converting the coordinates of the three-dimensional points of the omnidirectional TOF image data into a two-dimensional coordinate system (screen coordinate system) indicated by the omnidirectional RGB image data after the translation. Thus, the coordinates of the three-dimensional point of the omnidirectional TOF image data and the coordinates of the omnidirectional two-dimensional image information captured by the imaging unit 11 are matched with each other. The reprojection processor 147 associates the coordinates of the three-dimensional point of the omnidirectional TOF image data with the coordinates of the omnidirectional two-dimensional image information captured by the imaging unit 11.

The parallax calculator 149 calculates the parallax at each position from the deviation of the distance from the corresponding pixel obtained by the matching process. The parallax matching process uses the reprojection coordinates converted by the reprojection processor 147 to search for peripheral pixels at the position of the reprojection coordinates. This makes it possible to shorten the processing time and acquire more detailed and high-resolution distance information.

Segmentation data obtained by the semantic segmentation process of the semantic segmentation unit 148 may be used for the parallax matching process. In this case, more detailed and high-resolution distance information can be acquired.

In addition, the parallax matching process may be performed only on edges or only on portions with a strong feature amount, while the other portions may additionally use the omnidirectional TOF image data; that is, the features of the omnidirectional RGB image or probabilistic method may be used to perform the propagation process.

The semantic segmentation unit 148 uses deep learning to provide a segmentation label indicating an object for the input image of the measurement range. This further increases the reliability of the calculation because each pixel of the omnidirectional TOF image data can be constrained to any of a plurality of distance regions divided by distance.

The three-dimensional reconstruction processor 150 acquires the omnidirectional RGB image data from the RGB image data acquiring unit 142, reconstructs the omnidirectional three-dimensional data based on the distance information output by the parallax calculator 149, and outputs an omnidirectional high-density three-dimensional point cloud with color information being added to each 3D point. The three-dimensional reconstruction processor 150 is an example of a three-dimensional information determination unit configured to determine the three-dimensional information.

The determination unit 160 acquires the omnidirectional RGB image data from the RGB image data acquiring unit 142, acquires the omnidirectional TOF image data converted from the reprojection processor 147 into a two-dimensional coordinate system represented by the omnidirectional RGB image data, determines whether or not a specific object is reflected in the captured image, and outputs the determination result to the display controller 170 based on these data.

The display controller 170 acquires the omnidirectional RGB image data from the RGB image data acquiring unit 142 and displays the two-dimensional image information based on the acquired omnidirectional RGB image data on the display unit 20. The display controller 170 displays a display image including information representing the determination result acquired from the determination unit 160 and two-dimensional image information on the display unit 20.

The display controller 170 is an example of an output unit configured to output the two-dimensional image information captured by the imaging unit 11 apart from the three-dimensional information, and the display unit 20 is an example of a destination configured to output the two-dimensional image information.

The display controller 170 may acquire the omnidirectional three-dimensional data from the three-dimensional reconstruction processor 150 and display the three-dimensional information on the display unit 20. Specifically, the display controller 170 may select a case in which the two-dimensional image information is displayed on the display unit 20 and a case in which the three-dimensional information is displayed on the display unit 20, according to predetermined states. Accordingly, the display controller 170 can output two-dimensional image information apart from the three-dimensional information.

The transmitter-receiver 180 communicates with an external device by wired or wireless technology and transmits (outputs) the omnidirectional three-dimensional data output from the three-dimensional reconstruction processor 150 and the omnidirectional two-dimensional image information output from the RGB image data acquiring unit 142 to an external device 300 configured to perform the three-dimensional reconstruction processing via a network 400.

In this embodiment, the two-dimensional image information captured by the imaging unit 11 is “the original two-dimensional image information” for creating “the two-dimensional image data for display” or “the two-dimensional image data for display”. For example, when “two-dimensional image data for display” is generated from “original two-dimensional image information” within the imaging device 1, or when “original two-dimensional image information” is transmitted from the imaging device 1 to an external device, the external device may create “two-dimensional image data for display” from “original two-dimensional image information”.

The transmitter-receiver 180 is an example of an output unit configured to output three-dimensional information, and the external device 300 is an example of an output destination configured to output three-dimensional information.

The transmitter-receiver 180 does not transmit the omnidirectional two-dimensional image information but may transmit only the omnidirectional three-dimensional data. The transmitter-receiver 180 may be formed by an interface circuit with a portable storage medium such as an SD card or a personal computer.

Operation of Processing Circuit

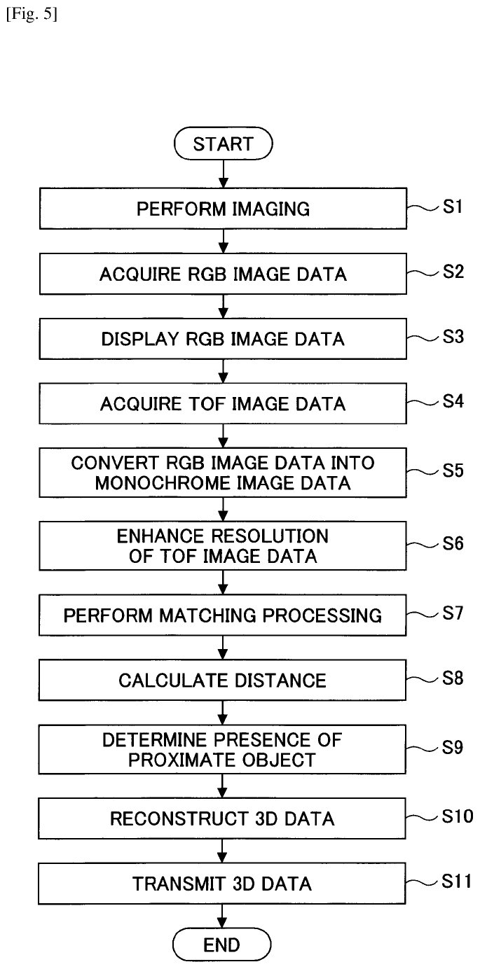

FIG. 5 is a flowchart illustrating an example of an operation of the processing circuit 14 of the imaging device 1. The controller 141 of the processing circuit 14 performs an operation to generate a high-density three-dimensional point cloud by the following method (an example of an imaging process method and an information processing method) when the shooting switch 15 is turned on by a user to input an imaging instruction signal.

First, in step S1, the controller 141 drives the light source units 12a and 12A, the TOF sensors 13a and 13A, and the image sensor elements 11a and 11A to image the measurement range. Driving by the controller 141 causes the light source units 12a and 12A to emit infrared light (an example of a projection step), and the TOF sensors 13a and 13A receive the reflected light (an example of a light receiving step). In addition, the image sensor elements 11a and 11A capture the measurement range at the timing of the start of the driving of the light source units 12a and 12A or during the period immediately before the start of the driving (an example of the imaging step).

Next, in step S2, the RGB image data acquiring unit 142 acquires the RGB image data in the measurement range from the image sensor elements 11a and 11A. In step S3, the display controller 170 acquires the omnidirectional RGB image data from the RGB image data acquiring unit 142 and displays the two-dimensional image information based on the acquired omnidirectional RGB image data on the display unit 20.

The display controller 170 displays the two-dimensional image information, which is a portion of the acquired omnidirectional RGB image data, on the display unit 20, and changes the area of the two-dimensional image information displayed on the display unit 20 by various inputs of the user. The various inputs of the user can be implemented by providing an operation switch other than the shooting switch 15 or by configuring the display unit 20 as an input unit of a touch panel or the like.

At this stage, the photographer can check, by looking at the two-dimensional image information displayed on the display unit 20, that the image of the photographer himself/herself or his/her tripod has been reflected in the captured image, or that a desired layout has not been acquired.

Next, in step S4, the TOF image data acquiring unit 144 acquires the TOF image data representing a distance from each position in the two-dimensional area from the TOF sensors 13a and 13A.

Next, in step S5, the monochrome processor 143 converts the RGB image data into a monochrome image. The TOF image data and the RGB image data differ in the data types of the distance data and the RGB data and cannot be matched as is. Thus, the data is first converted into a monochrome image. For TOF image data, the resolution enhancer 145 converts the value representing the distance of each pixel before enhancing its resolution into the value of the monochrome image.

Next, in step S6, the resolution enhancer 145 enhances a resolution of the TOF image data. Next, in step S7, the matching processor 146 extracts a feature amount of a portion of texture in each monochrome image and performs the matching process with the extracted feature amount.

Next, in step S8, the parallax calculator 149 calculates the parallax of each position from the parallax of the distance of the corresponding pixel and calculates the distance.

Next, the determination unit 160 acquires the omnidirectional RGB image data from the RGB image data acquiring unit 142, acquires the omnidirectional TOF image data converted from the reprojection processor 147 to a two-dimensional coordinate system indicated by the RGB image data, determines whether or not a proximate object is reflected in the captured image as a specific object based on these data, and outputs the determination result to the display controller 170 (an example of the determination step).

In step S9, the display controller 170 displays on the display unit 20 information representing the determination result acquired from the determination unit 160 that is superimposed on or included in the two-dimensional image information (an example of a display step). In step S9, the determination unit 160 determines whether or not there is a high reflection object, a distant object, a low reflection object, an image blur, etc. as well as a proximate object as a specific object and outputs the determination result to the display controller 170.

In step S10, the three-dimensional reconstruction processor 150 acquires the RGB image data from the RGB image data acquiring unit 142, reconstructs three-dimensional data based on the distance information output by the parallax calculator 149, and outputs a high-density three-dimensional point cloud with color information being added to each three-dimensional point.

Next, in step S11, the transmitter-receiver 180 transmits the three-dimensional data output from the three-dimensional reconstruction processor 150 and the two-dimensional image information output from the RGB image data acquiring unit 142 to the external device 300 configured to perform the three-dimensional reconstruction processing via the network 400 (an example of the three-dimensional information output step).

The transmitter-receiver 180 may transmit the three-dimensional data output from the three-dimensional reconstruction processor 150 without transmitting the two-dimensional image information output from the RGB image data acquiring unit 142.

As described above, the imaging device 1 includes the imaging unit 11 and a display controller 170 that output two-dimensional image information captured by the imaging unit 11 apart from the three-dimensional information.

This enables the photographer to easily identify from the two-dimensional image information without checking the three-dimensional information that the photographer himself/herself, his/her tripod, or the like has not been reflected in the captured image or that the three-dimensional information representing the desired layout has not been acquired.

Accordingly, it becomes possible to reacquire the three-dimensional information while being at the site where the three-dimensional information is to be acquired, and to reduce the time to revisit the site where the three-dimensional information is to be acquired, compared to a case where a photographer notices, after being away from the site where the three-dimensional information is to be acquired, that the photographer himself/herself, his/her tripod, or the like, has been reflected in the captured image or that the three-dimensional information of the desired layout has not been acquired.

The three-dimensional information includes omnidirectional three-dimensional information. In this case, even in the omnidirectional three-dimensional information, from which it is difficult for the photographer to identify that the photographer himself/herself, the tripod, or the like has been reflected in the captured image or that the three-dimensional information of the desired layout has not been acquired, the photographer is able to easily identify that the photographer himself/herself, his/her tripod, or the like has not been reflected in the captured image or that the three-dimensional information of the desired layout has not acquired, from the two-dimensional image information captured by the imaging unit 11.

The display controller 170 outputs two-dimensional image information G in step S3 before the transmitter-receiver 180 transmits (outputs) the three-dimensional information in step S11. The display controller 170 outputs the two-dimensional image information G in step S3 before the three-dimensional reconstruction processor 150 determines the three-dimensional information in step S10.

This enables the photographer to easily identify from the two-dimensional image information before checking the three-dimensional information that the photographer himself/herself, his/her tripod, or the like has been reflected in the captured image or that the three-dimensional information of the desired layout has not been acquired.

The display controller 170 displays two-dimensional image information on the display unit 20. The imaging device 1 includes a display unit 20.

This enables the photographer to easily identify from the two-dimensional image information displayed on the display unit 20 that the photographer himself/herself, his/her tripod, or the like has been reflected in the captured image or that the three-dimensional information of the desired layout has not been acquired.

The display controller 170 outputs the two-dimensional image information to the display unit 20 different from the external device 300 to which the transmitter-receiver 180 outputs the three-dimensional information.

This enables the photographer to easily identify, from the two-dimensional image information output to the display unit 20 different from the external device 300, that the photographer himself/herself, his/her tripod, or the like has been reflected in the captured image or that the desired three-dimensional information of the layout has not been acquired, without checking the three-dimensional information output to the external device 300.

The imaging device 1 includes a three-dimensional reconstruction processor 150 configured to determine three-dimensional information based on the output of the distance information acquiring unit 13. The three-dimensional reconstruction processor 150 determines the three-dimensional information, based on the output of the distance information acquiring unit 13 and the two-dimensional image information.

This enables a photographer to identify, from the two-dimensional image information captured by the imaging unit 11, that the photographer himself/herself, his/her tripod, or the like has been reflected in the captured image, or that the three-dimensional information of the desired layout has not been acquired, without checking the three-dimensional information determined by the three-dimensional reconstruction processor 150.

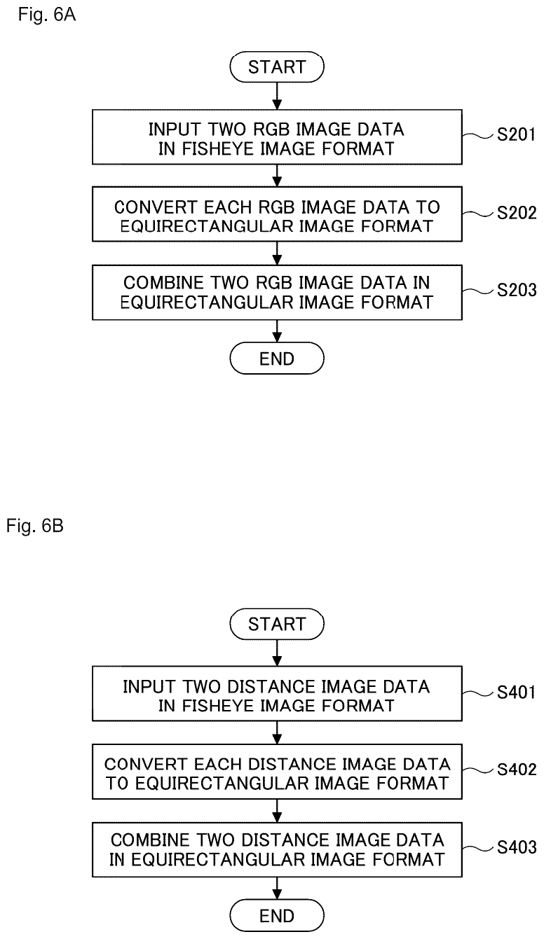

FIGS. 6A and 6B are flowcharts illustrating the generation of omnidirectional image data according to the embodiment.

FIG. 6A is a flowchart illustrating a process of generating the omnidirectional RGB image data, which corresponds to step S2 illustrated in FIG. 5.

In step S201, the RGB image data acquiring unit 142 inputs two RGB image data in the fisheye image format.

In step S202, the RGB image data acquiring unit 142 converts each RGB image data to an equirectangular image format. The RGB image data acquiring unit 142 converts the two RGB image data into an equirectangular image format based on the same coordinate system to facilitate image coupling in the next step. Note that the RGB image data can be converted to image data using one or more image formats other than the equirectangular image format if necessary. For example, The RGB image data can also be converted into coordinates of an image perspectively projected onto a desired surface or an image perspectively projected onto each surface of a desired polyhedron.

Herein, an equirectangular image format will be described. The equirectangular image format is a method that is capable of expressing an omnidirectional image, and is a form of an image (equirectangular image) created by using the equirectangular projection. The equirectangular projection is a projection that represents a three-dimensional direction with two variables, such as the latitude and longitude of a globe, and is displayed in a plane so that the latitude and longitude are orthogonal to each other. Accordingly, the equirectangular image is an image generated by using the equirectangular projection, and is represented by coordinates with two angular variables in the spherical coordinate system as two axes.

In step S203, the RGB image data acquiring unit 142 couples the two RGB image data generated in step S202 and generates one omnidirectional RGB image data. The two RGB image data inputs cover an area with a total field angle of over 180 degrees. Thus, the omnidirectional RGB image data generated by properly capturing the two RGB image data can cover a spherical area.

In addition, the coupling process in step S203 can use the existing technology for connecting multiple images, and the method is not particularly limited.

FIG. 6B is a flowchart illustrating a process of generating the omnidirectional TOF image data, which corresponds to step S4 illustrated in FIG. 5.

In step S401, the TOF image data acquiring unit 144 acquires two distance image data in the fisheye image format.

In step S402, the TOF image data acquiring unit 144 converts each of the two TOF image data in the fish eye image format to the equirectangular image format. The equirectangular image format, as described above, is a system capable of expressing an omnidirectional image. In step S402, the two TOF image data are converted to an equirectangular image format based on the same coordinate system, thereby facilitating image coupling in step S403.

In step S403, the TOF image data acquiring unit 144 couples two TOF image data generated in step S402 and generates one omnidirectional TOF image data. The two TOF image data inputs cover a total field of view of over 180 degrees. Hence, the omnidirectional TOF image data generated by properly capturing the two TOF image data can cover a spherical area.

In addition, the coupling process in step S403 can use the existing technology for making a plurality of images, and the method is not particularly limited.

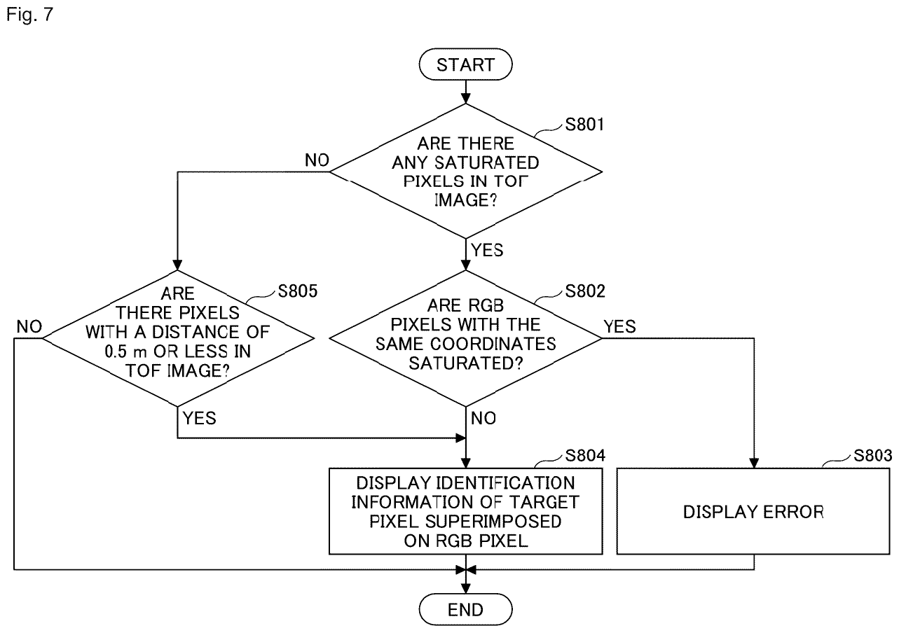

FIG. 7 is a flowchart illustrating the determination of a proximate object according to the embodiment.

FIG. 7 is a flowchart illustrating a process of determining whether or not a proximate object is reflected in the captured image, which corresponds to step S9 illustrated in FIG. 5.

In step S801, the determination unit 160 determines whether or not there is a pixel whose charged amount is saturated, as an example of a pixel whose charged amount is equal to or greater than a predetermined value, within the omnidirectional TOF image data obtained from the reprojection processor 147.

In step S802, when there is a pixel whose charged amount is saturated in step S801, the determination unit 160 determines, as an example of a pixel whose charged amount is equal to or greater than a predetermined value, whether or not the charged amount in a pixel having the same coordinates as the pixel whose charged amount is saturated in step S801 is saturated, in the omnidirectional RGB image data, based on the omnidirectional RGB image data acquired from the RGB image data acquiring unit 142.

When the pixel whose charged amount is saturated in step S802, the determination unit 160 determines that the pixel whose charged amount is saturated in step S801 is caused by external light (e.g., sunlight or illumination) and outputs error information to the display controller 170. In step S803, the display controller 170 displays a display image including the error information and two-dimensional image information on the display unit 20 based on the error information acquired from the determination unit 160.

When the charged amount is not saturated in step S802, the determination unit 160 determines that the pixel whose charged amount is saturated in step S801 is caused by the presence of a proximate object and outputs the coordinate position information of the pixel whose charged amount is saturated in step S801 to the display controller 170. In step S804, the display controller 170 displays a display image including identification information for identifying the proximate object and two-dimensional image information on the display unit 20, based on the coordinate position information of pixels acquired from the determination unit 160.

In step S805, when there is no pixel whose charged amount is saturated in step S801, the determination unit 160 determines whether or not there is any pixel representing the distance information of 0.5 m or less among the omnidirectional TOF image data, based on the TOF image data acquired from the reprojection processor 147.

When there is no pixel representing the distance information of 0.5 m or less in step S805, the determination unit 160 ends the process.

When there is a pixel representing the distance information of 0.5 m or less in step S805, the determination unit 160 proceeds to step S804 described above, determines that the pixel representing the distance information of 0.5 m or less in step S805 is due to the presence of a proximate object, and outputs the coordinate position information of the pixel representing the distance information of 0.5 m or less in step S805 to the display controller 170. The display controller 170 displays a display image including identification information for identifying the proximate object and two-dimensional image information, based on the coordinate position information of the pixels acquired from the determination unit 160.

As described above, the display controller 170 superimposes or includes the identification information in the two-dimensional image information when the determination unit 160 determines that the proximate object is present, and does not superimpose or include the identification information in the two-dimensional image information when the determination unit 160 determines that the proximate object is not present.

That is, the display controller 170 causes the display unit 20 to present a different display according to the presence or absence of a proximate object.

Also, the display controller 170 displays a display image including identification information for identifying a proximate object and two-dimensional image information, based on the coordinate position information of the pixels acquired from the determination unit 160.

That is, the display controller unit 170 causes the display unit 20 to present a different display at the position of the display unit 20 according to the position of the proximate object.

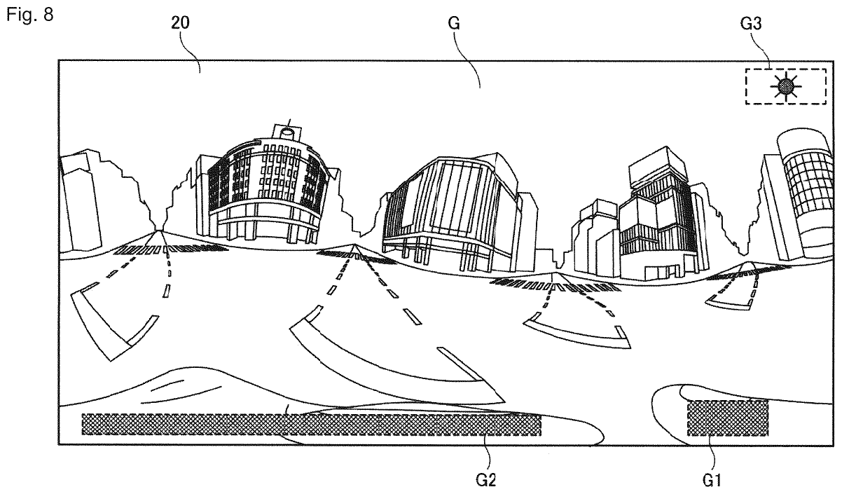

FIG. 8 is a diagram illustrating display contents of the display unit according to the embodiment.

FIG. 8 is a diagram corresponding to step S2 illustrated in FIG. 5, and step S803 and step S804 illustrated in FIG. 7.

The two-dimensional image information G is displayed on the display unit 20 by the display controller 170. The display unit 20 displays a display image including identification information G1, G2 (e.g., fingers, tripods) for identifying an object such as a proximate object and error information G3, and the two-dimensional image information G by the display controller 170. The error information G3 can be represented by a mark such as “sun, illumination” as illustrated in FIG. 8.

As described above, the imaging device 1 includes the imaging unit 11 configured to capture an image of an object, the projector 12 configured to project light to the object, the distance information acquiring unit 13 configured to receive light reflected from the object, and the display controller 170 configured to cause the display unit 20 to present a different display according to the presence or absence of an object, such as a proximate object determined based on the output of the distance information acquiring unit 13 and an output of the imaging unit 11.

This enables the photographer to accurately identify whether or not the photographer himself/herself or a proximate object, such as a tripod, has been reflected in the captured image by distinguishing the reflection of the photographer himself/herself or the proximate object from the effect of external light.

The imaging device 1 includes the display unit 20. This enables the photographer to reliably check whether or not the proximate object is reflected in the captured image.

The display controller unit 170 causes the display unit 20 to present a different display at the position of the display unit 20 according to the position of the proximate object. This enables the photographer to check the position of the proximate object reflected in the captured image.

The display controller 170 displays the image information G captured by the imaging unit 11 on the display unit 20 and displays the display image including the identification information G1 and G2 for identifying a proximate object and image information on the display unit 20. This enables the photographer to check the position of the proximate object reflected in the captured image.

The imaging device 1 includes the determination unit 160 configured to determine that the proximate object is present when the charged amount is saturated as an example of a pixel whose charged amount by light received by the distance information acquiring unit 13 is equal to or greater than the predetermined value, and when the charged amount is not saturated as an example of a pixel of the imaging unit 11 whose charged amount is equal to or less than the predetermined value.

This enables the photographer to accurately identify whether or not a proximate object is reflected in the captured image by distinguishing the reflection of the proximate object from the effect of external light.

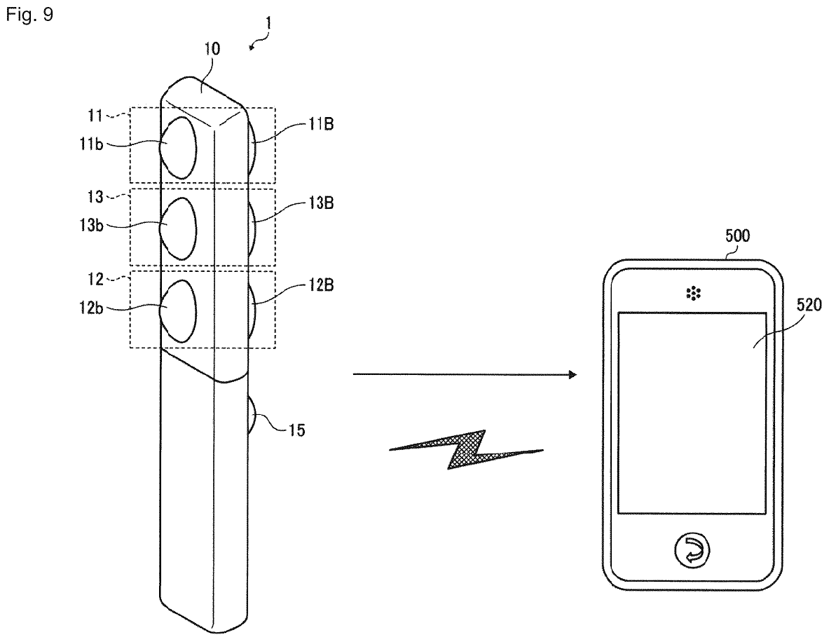

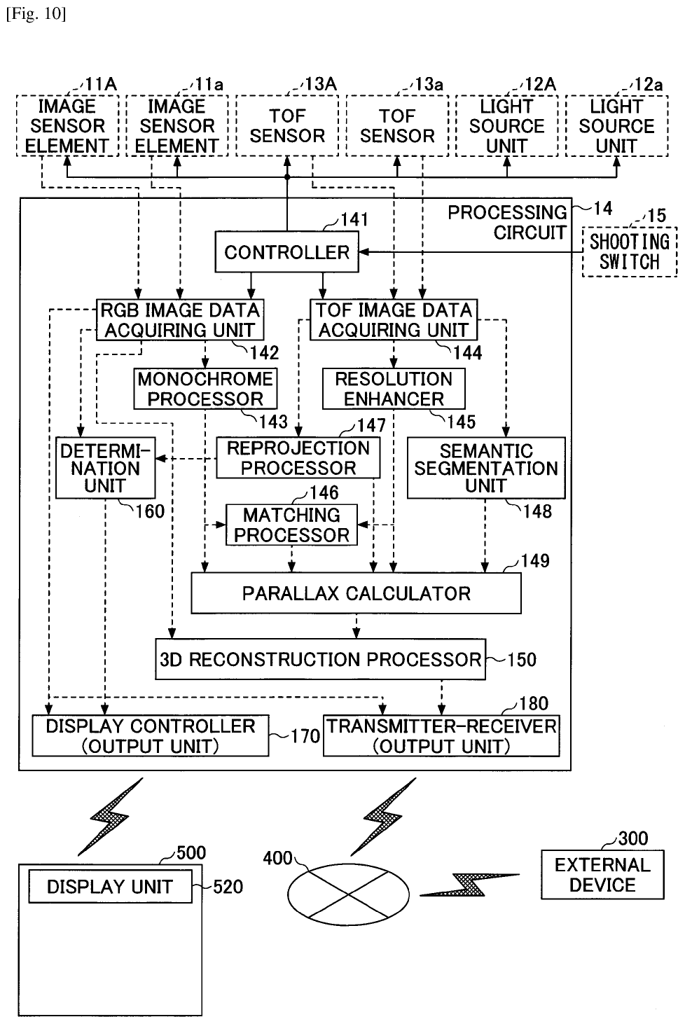

FIG. 9 is a diagram illustrating an appearance of an imaging device according to a modification of the embodiment. FIG. 10 is a diagram illustrating a configuration of a processing block of a processing circuit according to the modification.

In this modification, the display controller 170 acquires the omnidirectional RGB image data from the RGB image data acquiring unit 142 and displays the two-dimensional image information based on the acquired omnidirectional RGB image data on a display unit 520 of a display device 500. The display unit 520 is an example of a destination configured to output two-dimensional image information.

This enables the photographer to easily identify from the two-dimensional image information displayed on the display unit 520 that the photographer himself/herself, his/her tripod, or the like has been reflected in the captured image or that the three-dimensional information of the desired layout has not been acquired.

The display controller 170 outputs the two-dimensional image information on the display unit 520 different from the external device 300 to which the transmitter-receiver 180 outputs the three-dimensional information.

This enables the photographer to easily identify that the photographer himself/herself, his/her tripod or the like has been reflected in the captured image or that the three-dimensional information of desired layout has not been acquired, from the two-dimensional image information output to the display unit 520 different from the external device 300 without checking the three-dimensional information output to the external device 300.

The display controller 170 may acquire the omnidirectional three-dimensional data from the three-dimensional reconstruction processor 150 and display the three-dimensional information on the display unit 520. Specifically, the display controller 170 may select a case in which the two-dimensional image information is displayed on the display unit 520 and a case in which the three-dimensional information is displayed on the display unit 520 according to predetermined states. Accordingly, the display controller 170 can output the two-dimensional image information apart from the three-dimensional information.

The display controller 170 displays a display image including error information and two-dimensional image information on the display unit 520 based on error information acquired from the determination unit 160.

The display controller 170 displays a display image including identification information for identifying a proximate object and two-dimensional image information on the display unit 520, based on the coordinate position information of pixels acquired from the determination unit 160.

That is, the display controller 170 causes the display unit 520 to present a different display according to the presence or absence of the proximate object determined based on the output of the distance information acquiring unit 13 and the output of the imaging unit 11.

This enables the photographer to accurately identify whether or not the photographer himself/herself or a proximate object, such as a tripod, has been reflected in the captured image by distinguishing the reflection of the photographer or the proximate object from the effect of external light.

The display controller 170 causes the position of the display unit 520 to be displayed differently according to the position of the proximate object. This enables the photographer to identify a position of the projection of the proximate object into the image.

The display controller 170 displays the image information captured by the imaging unit 11 on the display unit 520 and displays a display image including identification information for identifying a proximate object and image information on the display unit 520. This enables the photographer to identify a position of proximate object reflected in the captured image.

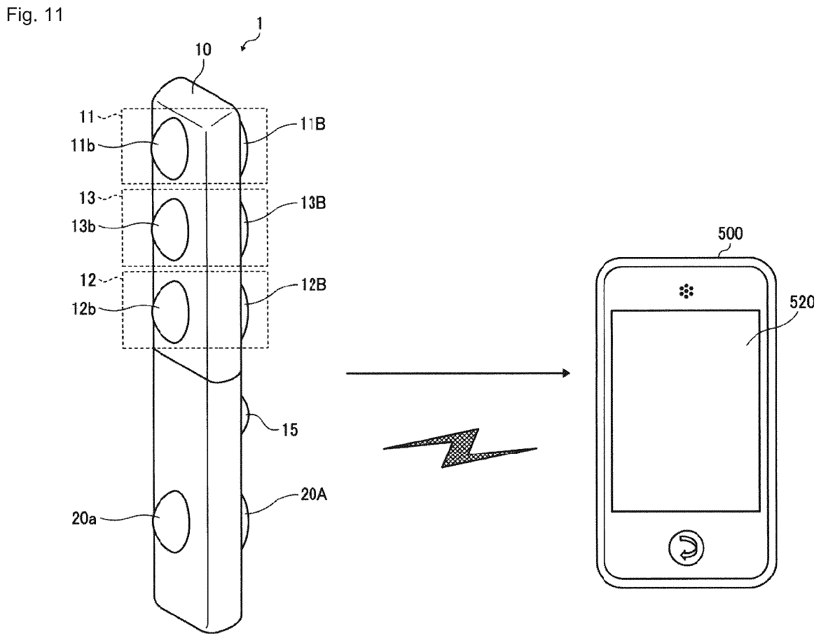

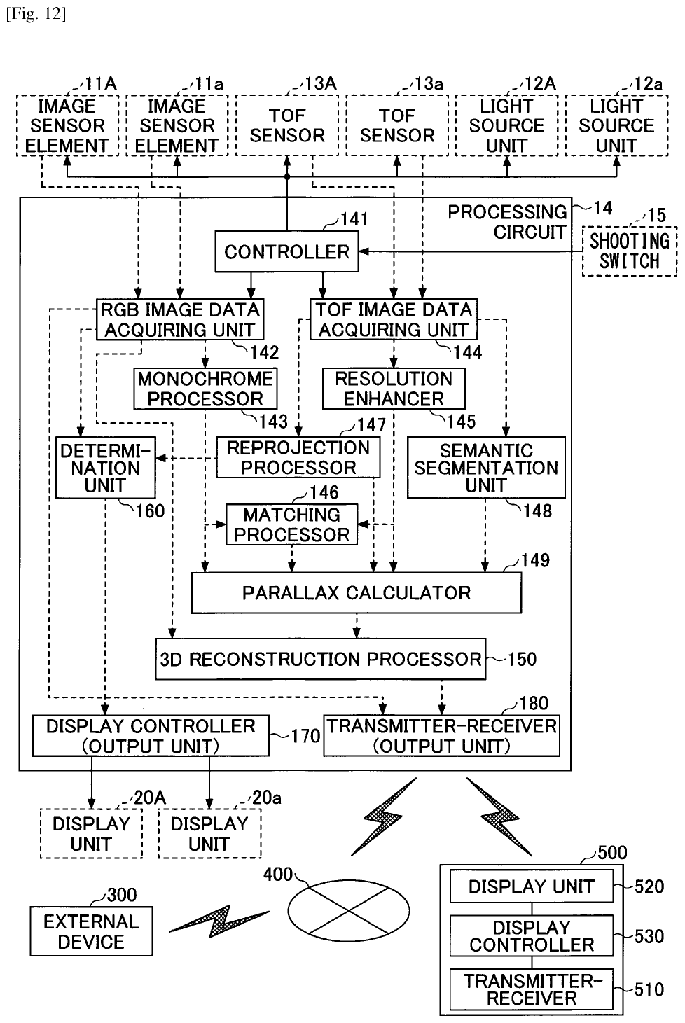

FIG. 11 is a diagram illustrating an appearance of an imaging device according to a second modification of the embodiment of the present disclosure. FIG. 12 is a diagram illustrating a configuration of a processing block of a processing circuit according to the second modification.

In the second modification illustrated in FIG. 11, the imaging device 1 includes a plurality of display units 20A and 20a instead of the display unit 20 illustrated in FIG. 1. The display units 20A and 20a are composed of LEDs or the like and blink or light according to the output signal of the processing circuit 14.

The display unit 20a is disposed on the first surface at the front side of the housing 10, and the display unit 20A is disposed on the second surface at the rear side of the housing 10.

In the second modification illustrated in FIG. 12, the display controller 170 displays information representing a determination result obtained from the determination unit 160 on the display units 20A and 20a. For example, the displays 20a and 20b may blink red when there is an object proximate to each side of the imaging device 1.

The transmitter-receiver 180 transmits (outputs) the omnidirectional two-dimensional image information output from the RGB image data acquiring unit 142 to the display device 500 through the network 400. The display device 500 is an example of an output destination for outputting two-dimensional image information.

That is, in the second modification, in step S3 illustrated in FIG. 5, the transmitter-receiver 180 acquires the omnidirectional RGB image data from the RGB image data acquiring unit 142 and transmits (outputs) the two-dimensional image information based on the acquired omnidirectional RGB image data to the display device 500.

The transmitter-receiver 510 of the display device 500 receives the two-dimensional image information transmitted from the transmitter-receiver 180 of the imaging device 1.

The display controller 530 of the display device 500 displays the two-dimensional image information received by the transmitter-receiver 510 to the display unit 520. The display device 500 including the display controller 530 is an example of an information processing device.

As described above, the imaging device 1 includes an imaging unit 11 and a transmitter-receiver 180 configured to output two-dimensional image information captured by the imaging unit 11 apart from the three-dimensional information.

This enables the photographer to easily identify, from the two-dimensional image information without checking the three-dimensional information, that the photographer himself/herself, his/her tripod, or the like has been reflected in the captured image or that the three-dimensional information of the desired layout has not been acquired.

Accordingly, it becomes possible to reacquire the three-dimensional information while being at the site where the three-dimensional information is to be acquired. This reduces the time to revisit the site where the three-dimensional information is to be acquired, compared to a case where the photographer notices that the photographer himself/herself, his/her tripod, or the like has been reflected in the captured image or that the desired three-dimensional information of the layout has not been acquired, after being away from the site where the three-dimensional information is to be acquired.

The transmitter-receiver 180 transmits (outputs) the two-dimensional image information G in step S3 before transmitting (outputting) the three-dimensional information in step S11. The transmitter-receiver 180 transmits (outputs) the two-dimensional image information G in step S3 before the three-dimensional reconstruction processor 150 determines the three-dimensional information in step S10.

This enables a photographer to identify that the photographer himself/herself, the tripod, or the like has been reflected in the captured image or that the three-dimensional information of the desired layout has not been acquired, from the two-dimensional image information before checking with the three-dimensional information.

The transmitter-receiver 180 transmits the two-dimensional image information to the display device 500, and the display device 500 displays the two-dimensional image information on the display unit 520.

This enables the photographer to easily identify from the two-dimensional image information displayed on the display unit 520 that the photographer himself/herself, his/her tripod, or the like has been reflected in the captured image or that the three-dimensional information of the desired layout has not been acquired.

The transmitter-receiver 180 transmits the two-dimensional image information to a display device 500 different from the external device 300 configured to output the three-dimensional information.

This enables the photographer to easily identify that the photographer himself/herself or his/her tripod or the like has been reflected in the captured image or that the three-dimensional information of the desired layout has not been acquired, from the two-dimensional image information output to the display unit 520 of the display device 500 different from the external device 300, without checking the three-dimensional information output to the external device 300.

The transmitter-receiver 180 may transmit the three-dimensional information to the display device 500. Specifically, the transmitter-receiver 180 may select a case in which the two-dimensional image information is transmitted to the display device 500, and a case in which the three-dimensional information is transmitted to the display device 500 according to predetermined states. Thus, the transmitter-receiver 180 can transmit the two-dimensional image information separately from the three-dimensional image information to the display device 500.

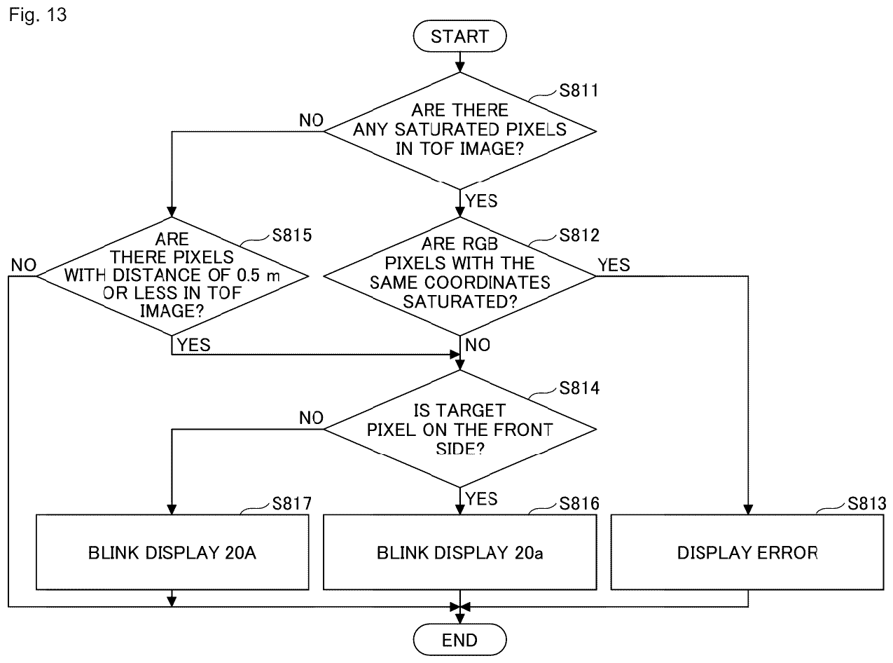

FIG. 13 is a flowchart illustrating a process of determining a proximate object according to a second modification.

FIG. 13 is a flowchart illustrating a process of determining whether or not a proximate object, which corresponds to step S9 illustrated in FIG. 5 is reflected in a captured image in the second modification.

In step S811, the determination unit 160 determines whether or not there is a pixel whose charged amount is saturated in the omnidirectional TOF image data obtained from the reprojection processor 147, as an example of a pixel whose charged amount is equal to or greater than a predetermined value.

In step S812, when there is a pixel whose charged amount is saturated in step S811, the determination unit 160 determines whether or not the charged amount in a pixel having the same coordinates as the pixel whose charged amount is saturated in step S811 is saturated, as an example of a pixel whose charged amount is equal to or greater than a predetermined value, in the omnidirectional RGB image data acquired from the RGB image data acquiring unit 142.

When the charged amount is saturated in step S812, the determination unit 160 determines that the pixel whose charged amount is saturated in step S811 is caused by external light and outputs the error information to the display controller 170. In step S813, the display controller 170 displays the error information on the display units 20A and 20a, based on the error information acquired from the determination unit 160.

When the charged amount is not saturated in step S812, the determination unit 160 determines that the pixel whose charged amount is saturated in step S811 is caused by the presence of a proximate object and outputs the coordinate position information of the pixel whose charged amount is saturated in step S811 to the display controller 170. In step S814, the display controller 170 determines whether or not the coordinate position information indicates the front side of the housing 10, based on the coordinate position information of the pixels acquired from the determination unit 160.

In step S815, when there is no pixel whose charged amount is saturated in step S811, the determination unit 160 determines whether or not there is any pixel representing the distance information of 0.5 m or less among the omnidirectional TOF image data, based on the omnidirectional TOF image data acquired from the reprojection processor 147.

When there is no pixel representing the distance information of 0.5 m or less in step S815, the determination unit 160 ends the process.

When there is a pixel representing the distance information of 0.5 m or less in step S815, the determination unit 160 progresses to step S814 as described above, determines that the pixel representing the distance information of 0.5 m or less in step S815 is caused by the presence of a proximate object, and outputs the coordinate position information of the pixel representing the distance information of 0.5 m or less in step S815 to the display controller 170. The display controller 170 determines whether or not the coordinate position information indicates the front side of the housing 10, based on the coordinate position information of the pixels acquired from the determination unit 160.

In step S816, the display controller 170 causes the display unit 20a disposed on the front side of the housing 10 to blink when the determination unit 160 determines that the coordinate position information indicates the front side of the housing 10 in step S814.

In step S817, the display controller 170 causes the display unit 20a disposed on the rear side of the housing 10 to blink when the determination unit 160 does not determine that the coordinate position information indicates the front side of the housing 10 in step S814.

As described above, the display controller 170 causes the display unit 20a or the display unit 20A to blink when the determination unit 160 determines that a proximate object is present, and does not cause the display unit 20a or the display unit 20A to blink when the determination unit 160 determines that a proximate object is not present.

That is, the display controller 170 causes the display unit 20a and the display unit 20A to present different displays according to the presence or absence of a proximate object.

This enables the photographer to accurately identify whether or not the photographer himself/herself or a proximate object, such as a tripod, has been reflected in the captured image by distinguishing the reflection of the photographer or proximate object from the effect of external light.

The display controller 170 causes the display unit 20a or the display unit 20A to blink based on the coordinate position information of pixels acquired from the determination unit 160.

That is, the display controller unit 170 causes the display unit 20a and the display unit 20A to present different displays, that is, according to the positions of the display units relative to the proximate object.

The display controller 170 causes any one of the display units 20A and 20a that is closer to the proximate object to present different display according to the presence or absence of the proximate object. This enables the photographer to check the position of the proximate object reflected in the captured image.

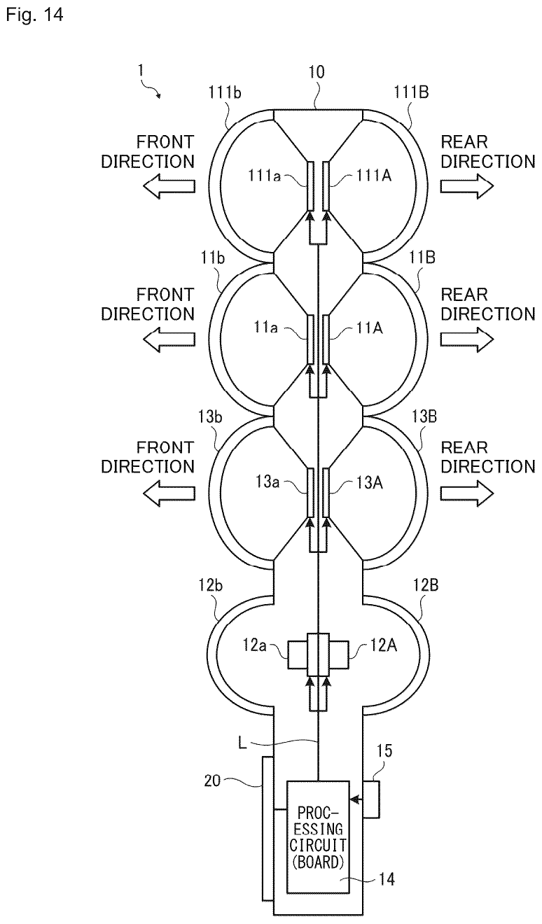

FIG. 14 is a diagram illustrating a configuration of an imaging device according to a third modification of the embodiment of the present disclosure.

In the third modification illustrated in FIG. 14, the imaging device 1 includes other image sensor elements 111a and 111A, and other imaging units 111 including other fisheye lenses (wide-angle lenses) 111b and 111B, in addition to the configuration illustrated in FIG. 2.

In the third modification, the imaging unit 11 of the RGB and the other imaging units 111 are disposed on the same baseline. In this case, processing in multiple eyes is possible in the processing circuit 14. That is, by simultaneously driving the imaging unit 11 and the other imaging units 111 disposed at a predetermined distance on one surface, RGB images of the two viewpoints are obtained. This enables the use of the parallax calculated based on the two RGB images and further improves the accuracy of the distance over the entire measurement range.

Specifically, when the imaging unit 11 of the RGB and the other imaging units 111 are disposed, a multi-baseline stereo (MSB) using the SSD, EPI processing, or the like can be used as in the conventional parallax calculation. This improves the reliability of the parallax, thereby implementing high spatial resolution and accuracy.

As described above, the imaging device 1 includes another imaging unit 111, and the three-dimensional reconstruction processor 150 configured to determine the three-dimensional information based on the output of the distance information acquiring unit 13, the two-dimensional image information, and other two-dimensional image information captured by the other imaging unit 111.

The imaging device 1 may include another imaging unit 111 and a three-dimensional information determination unit configured to determine the three-dimensional information based on the two-dimensional image information and the other two-dimensional image information captured by the other imaging unit 111 without using the output of the distance information acquiring unit 13.

This enables a photographer to identify, from the two-dimensional image information captured by the imaging unit 11, that the photographer himself/herself, his/her tripod, or the like has been reflected in the captured image or that the three-dimensional information of the desired layout has not been acquired, without checking the three-dimensional information determined by the three-dimensional reconstruction processor 150 based on the two-dimensional image information.

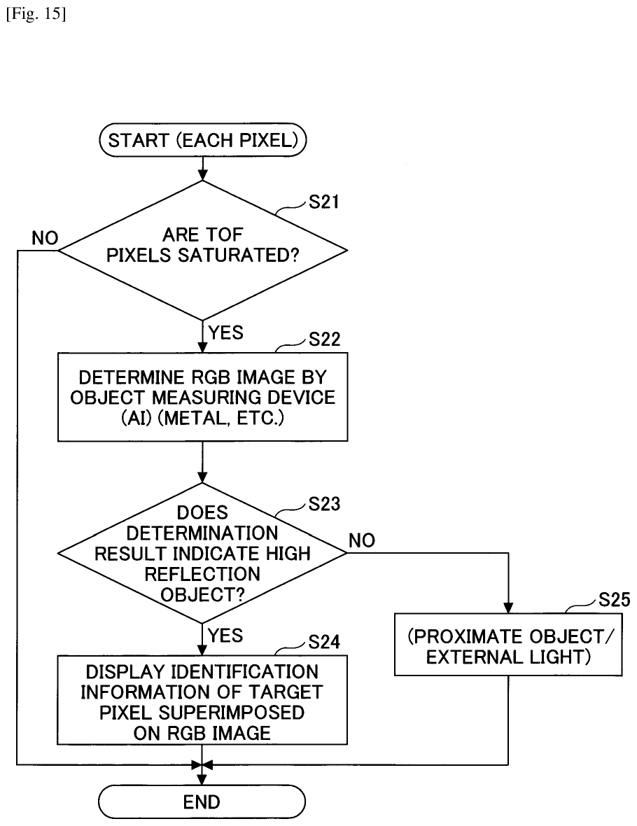

FIG. 15 is a flowchart illustrating a process of determining a high reflection object according to an embodiment of the present disclosure. FIG. 15 is a flowchart illustrating a process of determining whether or not a high reflection object is reflected in the captured image, which corresponds to step S9 illustrated in FIG. 5.

In step S21, the determination unit 160 determines, as an example of a pixel whose charged amount is equal to or greater than a predetermined value, whether or not there is a pixel whose charged amount is saturated within omnidirectional TOF image data, based on the omnidirectional TOF image data obtained from the reprojection processor 147.

In step S22, when there is a pixel whose charged amount is saturated in step S21, the determination unit 160 determines whether or not, in the omnidirectional RGB image data, the RGB image data including a pixel with the same coordinates as the pixel whose charged amount is saturated in step S21 is matched with reference information representing a high reflection object, based on the RGB image data acquired from the RGB image data acquiring unit 142. As the reference information indicating a high reflection object, model image information may be used to determine a matching degree between the RGB image data and the model image information obtained by image recognition. In addition, as reference information indicating a high reflection object and RGB image data, a parameter such as a spectrum and a color tone may be used to determine a matching degree based on a predetermined threshold. In addition, the reference information may be stored in a table or a learning model may be used.

The processing circuit 14 stores an image of a high reflection object, such as a metal or a mirror, as model image information. In step S22, the determination unit 160 determines whether or not the acquired image matches the image of the high reflection object stored by using a determination device, such as AI.

In step S23, the determination unit 160 outputs the coordinate position information of the pixel determined in step S22 to the display controller 170 when determination unit 160 determines that the image acquired in step S22 matches the stored image of the high reflection object. The display controller 170 displays a display image including identification information for identifying a high reflection object and two-dimensional image information on the display units 20 and 520, based on the coordinate position information of pixels acquired from the determination unit 160 (step S24), and ends the process.

Step S22 and step S23 are examples of determination steps, and step S24 is an example of a display steps.

In step S25, when the determination unit 160 determines that the image acquired in step S22 does not match the stored image of the high reflection object, the determination unit 160 proceeds to the determination of the proximate object (step S23) and performs the proximate object determination flowchart illustrated in FIG. 7.

As described above, the imaging device 1 includes the determination unit 160 configured to determine whether a high reflection object is present based on both an output of the distance information acquiring unit 13 and an output of the imaging unit 11, and the display controller 170 configured to cause the display units 20 and 520 to present different displays according to the presence or absence of at least one of the high reflection object, the low reflection object, the distant object, or the image blur.

This enables the photographer to accurately identify that a high reflection object, such as a mirror, is included in the captured image, as distinguished from the effect of a proximate object or external light.

The imaging device 1 includes the display unit 20. This enables the photographer to identify that a high reflection object is included in the captured image.

The display controller 170 causes the display units 20 and 520 to present different displays according to the position of the high reflection object. This enables the photographer to reliably identify a position of the high reflection object.

Similar to the proximate object illustrated in FIG. 13, the display unit 20 includes a plurality of display units 20A and 20a, and the display controller 170 causes one of the display units 20A and 20a located closer to the high reflection object to present different displays according to the presence or absence of an object. This enables the photographer to reliably identify a position of a high reflection object.

Similar to the proximate object illustrated in FIGS. 3A to 3D, the display controller 170 displays the image information G captured by the imaging unit 11 on the display units 20 and 520, and displays display images including identification information for identifying a high reflection object and image information G. This enables the photographer to reliably identify a position of a high reflection object.

The determination unit 160 determines that there is a high reflection object when the charged amount in the pixel is saturated as an example of a pixel whose charged amount by light received by the distance information acquiring unit 13 is equal to or greater than a predetermined value, and when the image information captured by the imaging unit matches model image information as an example of reference information representing a high reflection object.

This enables the photographer to accurately identify that a high reflection object is included in the captured image, as distinguished from the effect of a proximate object or external light.

The imaging device 1 acquires information of distance (distance information) to an object, based on the light received by the distance information acquiring unit 13. In this case, the photographer can identify that the factor of not acquiring the desired distance information is not the proximate object or external light but a high reflection object.

The imaging device 1 includes the transmitter-receiver 180 configured to output three-dimensional information determined based on distance information acquired from the distance information acquiring unit 13. In this case, the photographer can identify that the factor of not acquiring the desired three-dimensional information is a high reflection object, not a proximate object or external light.

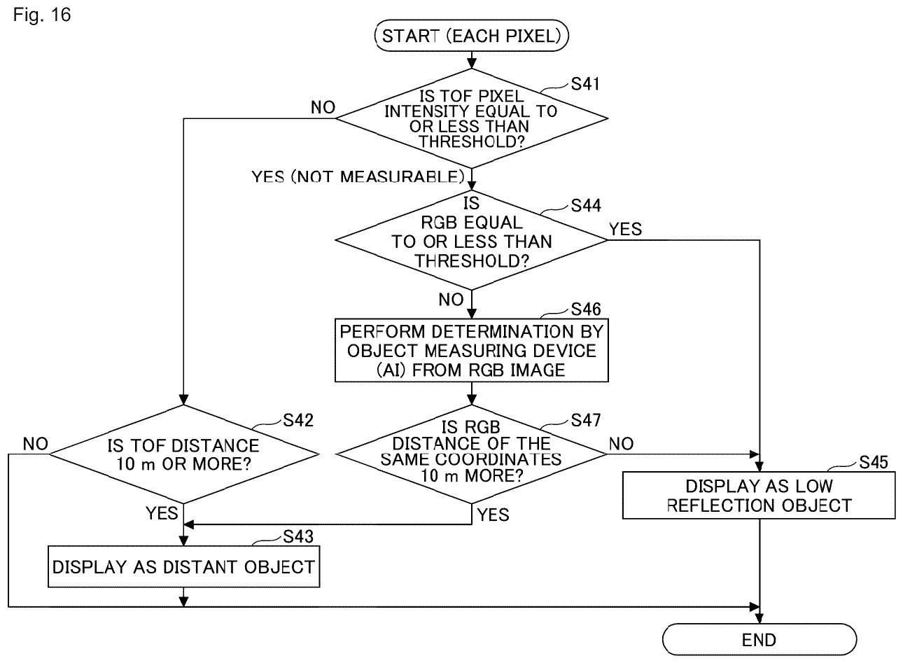

FIG. 16 is a flowchart illustrating a process of determining a distant object and a low reflection object according to the present embodiment. FIG. 16 is a flowchart illustrating whether or not a distant object and a low reflection object are reflected in a captured image, which corresponds to step S9 illustrated in FIG. 5.

In step S41, the determination unit 160 determines whether or not there is a pixel in the omnidirectional TOF image data whose charged amount is equal to or less than a threshold for acquiring distance information, based on the omnidirectional TOF image data acquired from the reprojection processor 147.

In step S42, when there is no pixel whose charged amount is equal to or less than the threshold in step S41, the determination unit 160 determines whether or not there is a pixel representing the distance information of 10 m or more in the omnidirectional TOF image data, based on the omnidirectional TOF image data acquired from the reprojection processor 147. When there is a pixel representing the distance information of 10 m or more, the determination unit 160 determines that there is a distant object, and outputs coordinate position information of the pixel to the display controller 170.

The display controller 170 displays a display image including identification information for identifying a distant object and two-dimensional image information on the display units 20 and 520, based on coordinate position information of the pixels acquired from the determination unit 160 (step S43) and ends the process.

When there is no pixel representing the distance information of 10 m or more in step S42, the determination unit 160 ends the process.

In step S44, when there is a pixel whose charged amount is equal to or less than the threshold in step S41, the determination unit 160 determines whether or not the charged amount in a pixel having the same coordinate as the pixel whose charged amount is equal to or less than the threshold in step S41 is equal to or less than an object recognizable threshold, in the omnidirectional RGB image data, based on the omnidirectional RGB image data obtained from the RGB image data acquiring unit 142.

When the determination unit 160 determines that the charged amount in the pixel is equal to or less than the object recognizable threshold in step S44, the determination unit 160 determines that the pixel indicates a low reflection object and outputs the coordinate position information of the pixel to the display controller 170.

The display controller 170 displays a display image including identification information for identifying a low reflection object and two-dimensional image information on the display units 20 and 520 based on the coordinate position information of the pixel acquired from the determination unit 160 (step S45) and ends the process.

When the determination unit 160 determines that the charged amount in the pixel is not equal to or less than the object recognizable threshold in step S44, the determination unit 160 determines the distance for the RGB image data including the pixel determined in step S44, based on model image information as an example of reference information in which the distances are associated with the images. When the model image information is used as the reference information, a matching degree between the RGB image data and the model image information may be determined by image recognition. In addition, as the reference information indicating the high reflection object and the RGB image data, parameters such as spectrum and hue may be used to determine the matching degree according to a predetermined threshold. In addition, the reference information may be stored in a table or a learning model may be used.

The processing circuit 14 stores, as model image information, respective images associated with a plurality of different distances. In step S46, the determination unit 160 determines whether the acquired image matches each of the images associated with the plurality of distances using a determination device such as AI.

In step S47, the determination unit 160 determines whether or not the distance associated with the image acquired in step S46 is 10 m or more, and when the distance is 10 m or more, determines that the image associated with the distance is a distant object, outputs coordinate position information of the pixel to the display controller 170, and proceeds to step S43.

When the distance associated with the image acquired in step S46 is not 10 m or more, the determination unit 160 determines that the image associated with the distance is a low reflection object, outputs coordinate position information of the pixel to the display controller 170 (step S47), and proceeds to step S45.

Steps S41, S42, S44, and S47 are examples of determination steps, and steps S43 and S45 are examples of display steps.

As described above, the imaging device 1 includes the determination unit 160 configured to determine whether or not there is a distant object or a low reflection object based on both an output of the distance information acquiring unit 13 and an output of the imaging unit 11, and the display controller 170 configured to cause the display units 20 and 520 to present different displays according to whether or not there is a distant object or a low reflection object.

This enables the photographer to accurately identify that a distant object or a low reflection object, such as black, is included in the captured image.

The imaging device 1 includes the display unit 20. This enables the photographer to accurately identify that a distant object or a low reflection object is included in the captured image.

The display controller 170 causes the display units 20 and 520 to present different displays according to a position of a distant object or a low reflection object. This enables the photographer to identify a position of a distant object or a low reflection object.

Similar to the proximate object illustrated in FIG. 13, the display unit 20 includes a plurality of display units 20A and 20a, and the display controller 170 causes one of the display units 20A and 20a closer to a distant object or a low reflection object to present a different display, according to the presence or absence of the object. This enables the photographer to reliably identify a position of a distant object or a low reflection object.

Similar to the proximate object illustrated in FIGS. 3A to 3D, the display controller 170 displays the image information G captured by imaging unit 11 on the display units 20 and 520, and displays display images including identification information for identifying a distant object or a low reflection object and image information G on the display units 20 and 520. This enables the photographer to reliably identify a position of a distant object or a low reflection object.

When the distance information acquiring unit 13 receives the charged amount in the pixel by the received light that is not more than the threshold, the determination unit 160 determines whether it is a low reflection object or a distant object based on the output of the imaging unit 11. This enables the photographer to accurately identify that a low reflection object or a distant object is included in the captured image.

The determination unit 160 determines that there is a low reflection object when the charged amount in the pixel by the light received by the distance information acquiring unit 13 is equal to or less than the threshold and the charged amount in the pixel of the imaging unit 11 is equal to or less than the threshold. This enables the photographer to accurately identify that a low reflection object is included in the captured image.

The determination unit 160 determines that there is a distant object when the charged amount in the pixel by the light received by the distance information acquiring unit 13 is equal to or less than the threshold, and the charged amount in the pixel of the imaging unit 11 is equal to or greater than the threshold and the distance determined based on the pixel is equal to or greater than the threshold.

This enables the photographer to accurately identify that a distant object is included in the captured image.

The imaging device 1 acquires distance information to an object based on the light received by the distance information acquiring unit 13. In this case, the photographer can identify that the factor of not acquiring the desired distance information is a distant object or a low reflection object.

The imaging device 1 includes a transmitter-receiver 180 as an example of an output unit configured to output three-dimensional information determined based on distance information acquired from the distance information acquiring unit 13. In this case, the photographer can identify that the factor of not acquiring the desired three-dimensional information is a distant object or a low reflection object.

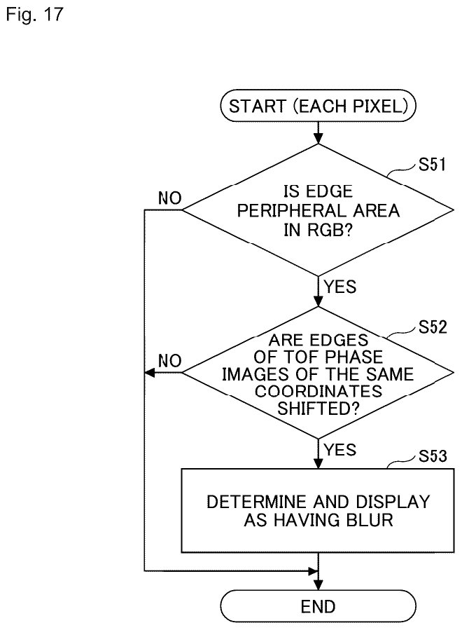

FIG. 17 is a flowchart illustrating a process of determining the presence or absence of image blur in the captured image, which corresponds to step S9 illustrated in FIG. 5.

The determination unit 160 determines whether or not there is a pixel of an image including an edge peripheral area in the omnidirectional RGB image, based on the omnidirectional RGB image data acquired from the RGB image data acquiring unit 142 (step S51).

Herein, the determination unit 160 detects an edge included in the captured image by comparing a change in the luminance value in the pixels or its first-order and second-order differential value with the threshold, and identifies the pixel of the image including the edge peripheral area; however, the determination unit 160 may detect the edge by other methods.

Next, when there is a pixel of the image that includes the edge peripheral area in step S51, the determination unit 160 determines, based on the omnidirectional TOF image data obtained from the reprojection processor 147, whether the edge of the TOF phase image is shifted in the TOF image data that includes a pixel having the same coordinates as the pixel of the image determined to include the edge peripheral area in step S51, among the omnidirectional TOF image data. When the determination unit 160 determines that the edge of the TOF phase image is shifted in the TOF image data, the coordinate position information of the pixel determined in step S51 is output to the display controller 170 (step S52).

The display controller 170 displays a display image including identification information for identifying image blur and two-dimensional image information on the display units 20 and 520 based on the coordinate position information of pixels acquired from the determination unit 160 (step S53) and ends the process.

Steps S51 and S52 are examples of determination steps, and step S53 is an example of display step.

When there is no pixel of the image including the edge peripheral area in step S51, and when the edge of the TOF phase image is not shifted in step S52, the determination unit 160 ends the process.

In this embodiment, a distance is measured by a phase difference detection method, and the imaging device 1 acquires and adds N TOF phase images of the same phase for each of the 0°, 90°, 180°, and 270° phases.

Thus, adding N phase images of the same phase expands a dynamic range of the phase image of the corresponding phase. In addition, the time required for imaging N phase images added in each phase is shortened, so that a phase image with superior position accuracy that is less affected by a blur or the like is obtained. Thus, a process of detecting the shifted amount of the image illustrated below can be performed accurately by the phase image with the expanded dynamic range.

The determination unit 160 may determine whether or not there is an image blur as follows. The determination unit 160 calculates a shifted amount of a pixel on a per phase basis by a process of determining a general optical flow or by calculating using a mechanical learning method disclosed in the following reference paper, and comparing the value obtained by adding the shifted amount of the pixel on a per phase basis for all the phases with the threshold. However, the determination unit 160 may use other methods to determine whether or not there is an image blur.
Name of paper: Tackling 3D To F Artifacts Through Learning and the FLAT Dataset
Author: Qi Guo (SEAS, Harvard University), Iuri Frosio Orazio Gallo Todd Zickler (SEAS, Harvard University) Jan Kautz
Publication date: Monday, Sep. 10, 2018
Published by: European Conference on Computer Vision 2018 URL https://research.nvidia.com/publication/2018-09_Tackling-3D-ToF

As described above, the imaging device 1 includes the determination unit 160 configured to determine whether there is an image blur based on both an output of the distance information acquiring unit 13 and an output of the imaging unit 11, and a display controller 170 configured to cause the display units 20 and 520 to present different displays according to the presence or absence of an image blur.

This enables the photographer to accurately identify that an image blur is included in the captured image.

The imaging device 1 includes the display unit 20. This enables the photographer to accurately identify that an image blur is included in the captured image.

The display controller 170 causes the display units 20 and 520 to present different displays according to the position of the image blur. This enables the photographer to check the position of the image blur.

As in the proximate object illustrated in FIG. 13, the display unit 20 includes a plurality of display units 20A and 20a, and the display controller 170 causes one of the display units 20A and 20a located closer to the position of the image blur to present different displays according to the presence or absence of the object. This enables the photographer to accurately identify that an image blur is included in the captured image.

Similar to the proximate object illustrated in FIGS. 3A to 3D, the display controller 170 displays the image information G captured by the imaging unit 11 on the display units 20 and 520 while displaying display images including identification information for identifying image blur and image information on the display units 20 and 52. This enables the photographer to accurately identify that an image blur is included in the captured image.

The determination unit 160 detects the edge of the image based on the image information captured by the imaging unit 11 and determines that there is an image blur when the pixel shift occurs due to the light received by the distance information acquiring unit 13.

This enables the photographer to accurately identify that an image blur is included in the captured image.

The imaging device 1 acquires distance information to an object based on the light received by the distance information acquiring unit 13. In this case, the photographer can identify that the factor of not acquiring the desired distance information is an image blur.

The imaging device 1 includes the transmitter-receiver 180 as an example of an output unit configured to output three-dimensional information determined based on distance information acquired from the distance information acquiring unit 13. In this case, the photographer can identify that the factor of not acquiring the desired three-dimensional information is an image blur.

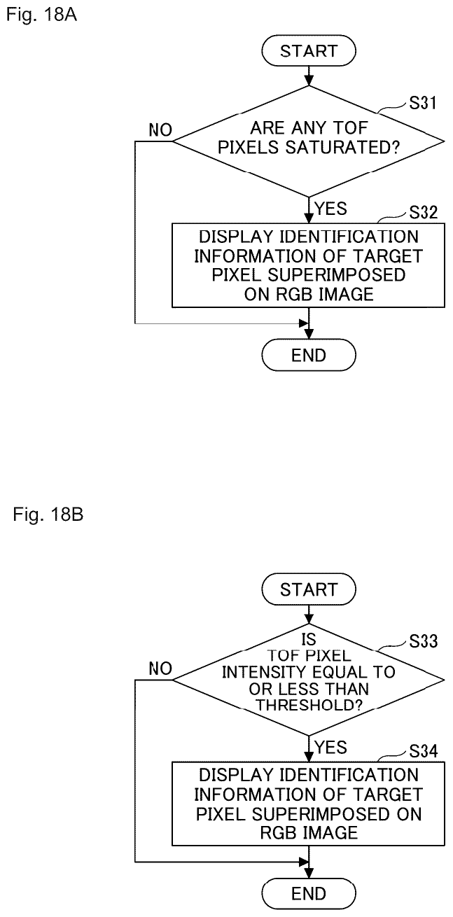

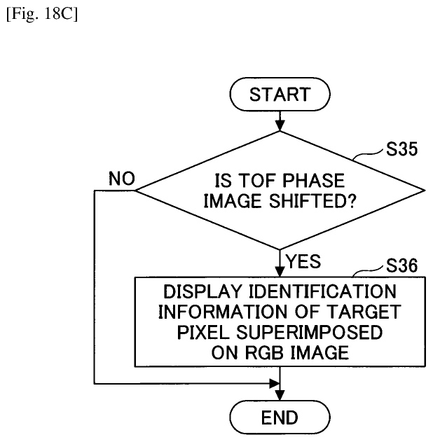

FIGS. 18A to 18C are each a flowchart illustrating a determination process according to a fourth modification of the embodiment of the present disclosure.

In step S9 illustrated in FIG. 5, the determination unit 160 determines the presence or absence of a specific object, such as the proximate object, and the display controller 170 causes the display units 20 and 520 to present different displays according to the presence or absence of a specific object. However, in the fourth modification, the determination unit 160 does not determine the presence or absence of a specific object, and the display controller 170 does not cause the display units 20 and 520 to present different displays according to the presence or absence of a specific object, but enables the user to recognize the specific object.

In the flowchart illustrated in FIG. 18A, the determination unit 160 determines, based on the omnidirectional TOF image data acquired from the reprojection processor 147, that there is a pixel in the omnidirectional TOF image data whose charged amount is saturated and whose charged amount is equal to or greater than a threshold for acquiring distance information, as an example of a pixel whose charged amount is equal to or greater than a predetermined value, and when there is a pixel whose charged amount is equal to or greater than the threshold for acquiring distance information, the determination unit 160 outputs the coordinate position information of the pixel to the display controller 170 (step S31).

In step S32, the display controller 170 displays a display image including position identification information for identifying a position and two-dimensional image information on the display units 20 and 520, based on coordinate position information of the pixel acquired from the determination unit 160, in the same manner as the proximate object illustrated in FIGS. 3A to 3D, and ends the process.

The determination unit 160 ends the process when the charged amount is not greater than the threshold in step S31.

In the flowchart illustrated in FIG. 18B, the determination unit 160 determines whether or not there is a pixel in the omnidirectional TOF image data whose charged amount is equal to or less than the threshold for acquiring distance information, based on the omnidirectional TOF image data acquired from the reprojection processor 147, and outputs coordinate position information of the pixel to the display controller 170 when there are pixels whose charged amount is equal to or less than the threshold (step S33).

In step S34, the display controller 170 displays a display image including position identification information for identifying a position and two-dimensional image information on the display units 20 and 520, based on the coordinate position information of the pixel acquired from the determination unit 160 and ends the process, as in the proximate object illustrated in FIGS. 3A to 3D.

The determination unit 160 ends the process when the charged amount is not equal to or less than the threshold in step S33.

In the flowchart illustrated in FIG. 18C, based on the omnidirectional TOF image data acquired from the reprojection processor 147, the determination unit 160 determines whether or not there is a pixel whose TOF phase image is shifted and whose distance information cannot be acquired in the omnidirectional TOF image data. When there is a pixel whose TOF phase image is shifted, the coordinate position information of the pixel is output to the display controller 170 (step S35).

Herein, the determination unit 160 determines the shift of the TOF phase image by the same method as that described in step S52 of FIG. 17.

In step S36, the display controller 170 displays a display image including position identification information for identifying a position and two-dimensional image information on the display units 20 and 520, based on the coordinate position information of the pixel acquired from the determination unit 160 and ends the process, as in the proximate object illustrated in FIGS. 3A to 3D.

When there is no pixel whose TOF phase image is shifted, the determination unit 160 ends the process.

As described above, the imaging device 1 includes the display controller 170 configured to display, on the display units 20 and 520, a display image including position identification information for identifying a position based on the position information representing a position determined by the determination unit 160 at which an output of the distance information acquiring unit 13 is equal to or greater than a threshold or equal to or less than a threshold, and two-dimensional image information G captured by the imaging unit 11 configured to capture an image of an object.

This enables a user to identify a factor of not acquiring the desired output by identifying, with the two-dimensional image G, the position at which the output of the distance information acquiring unit 13 is equal to or greater than the threshold or equal to or less than the threshold, that is, the position at which the output of the distance information acquiring unit 13 is too strong or too weak to obtain the desired output, and thus it is possible to identify the factors that prevent the desired output from being obtained.

The imaging device 1 includes a display controller 170 configured to display, on the display units 20 and 520, a display image including position identification information for identifying a position based on position information determined by the determination unit 160 at which distance information to an object cannot be obtained based on the output of the distance information acquiring unit 13, and two-dimensional image information G captured by the imaging unit 11 configured to capture an image of an object.

This enables a user to identify the position at which the distance information to the object cannot be acquired with the two-dimensional image G, so as to identify a factor of not acquiring the distance information to the object.

The determination units 160, 560, and 660 determine that the distance to the object information cannot be acquired by not only when the output of the distance information acquiring unit 13 is equal to or greater than the threshold but also when an image blur is detected by the output of the distance information acquiring unit 13.

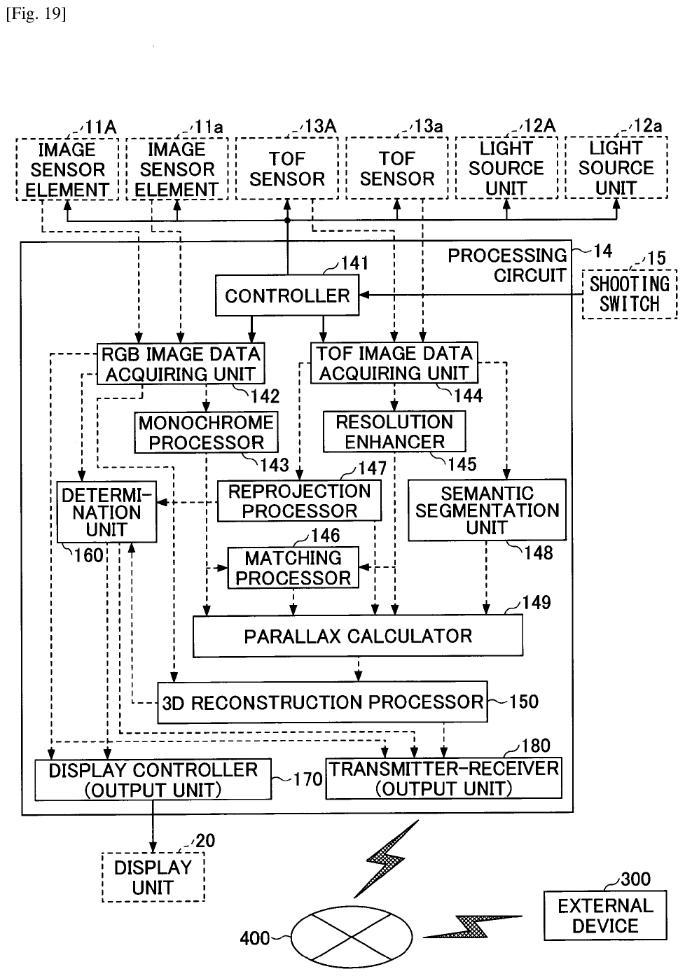

FIG. 19 is a diagram illustrating an example of a configuration of a processing block of a processing circuit according to a fifth modification of the embodiment of the present disclosure.

The processing block of the processing circuit according to the fifth modification illustrated in FIG. 19, differs from the processing block of the processing circuit 14 according to the present embodiment illustrated in FIG. 4, in that the determination unit 160 outputs a determination result to the transmitter-receiver 180, the determination unit 160 acquires omnidirectional three-dimensional data from the three-dimensional reconstruction processor 150, outputs a determination result to the transmitter-receiver 180, and the display controller 170 acquires omnidirectional three-dimensional data from the three-dimensional reconstruction processor 150.

The transmitter-receiver 180 transmits (outputs) the determination result of the determination unit 160 to the external device 300 configured to perform the three-dimensional reconstruction processing via the network 400, in addition to the omnidirectional three-dimensional data output from the three-dimensional reconstruction processor 150 and the omnidirectional two-dimensional image information output from the RGB image data acquiring unit 142.

The display controller 170 displays a three-dimensional image on the display unit 20 based on the omnidirectional three-dimensional data acquired from the three-dimensional reconstruction processor 150 and displays a display image including identification information for identifying a specific object and a three-dimensional image based on a determination result of the determination unit 160 configured to determine whether the specific object is present based on both an output of the imaging unit 11 and an output of the distance information acquiring unit 13. Examples of the specific object include a proximate object, a high reflection object, a distant object, a low reflection object, and an image blur area.

This enables a user to view the three-dimensional image 3G to identify the factor of not displaying the desired three-dimensional image 3G being any one of a distant object, a low reflection object, a blind spot, a proximate object, a high reflection object, and an image blur.

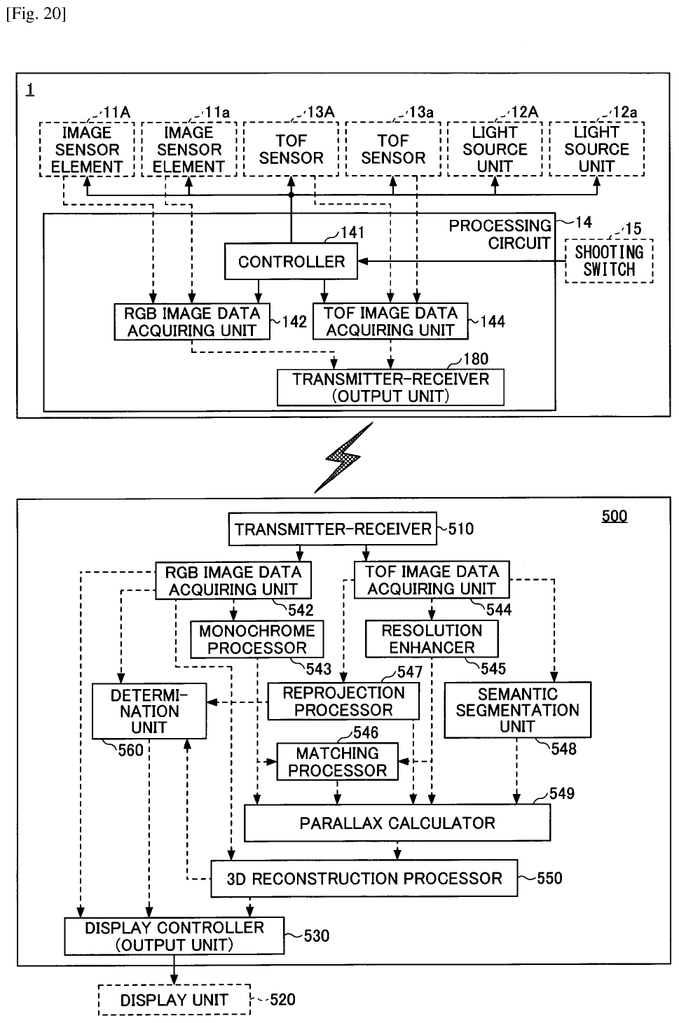

FIG. 20 is a diagram illustrating an example of a configuration of an information processing system according to a sixth modification of the embodiment of the present disclosure.

The information processing system according to the sixth modification illustrated in FIG. 20 includes an imaging device 1 and a display device 500.

The imaging device 1 illustrated in FIG. 20 includes image sensor elements 11a, 11A, TOF sensors 13a, 13A, light source units 12a, 12A, and a shooting switch 15, which are configured in the same manner as those illustrated in FIG. 4.

The processing circuit 4 of the imaging device 1 illustrated in FIG. 20 includes a controller 141, an RGB image data acquiring unit 142, a TOF image data acquiring unit 144, and a transmitter-receiver 180. The controller 141 is configured in the same manner as that illustrated in FIG. 4.

As in FIG. 4, the RGB image data acquiring unit 142 acquires the RGB image data captured by the image sensor elements 11a and 11A, based on an imaging instruction by the controller 141 and outputs omnidirectional RGB image data. However, the RGB image data acquiring unit 142 differs from FIG. 4 in that the output destination is the transmitter-receiver 180.

Similar to FIG. 4, the TOF image data acquiring unit 144 is configured to acquire TOF image data generated by the TOF sensors 13a and 13A and outputs the omnidirectional TOF image data based on the instruction for generating the TOF image data by the controller 141. However, the configuration of the TOF image data acquiring unit 144 differs from FIG. 4 in that an output destination is the transmitter-receiver 180.

Unlike FIG. 4, the transmitter-receiver 180 transmits (outputs) the omnidirectional RGB image data output from the RGB image data acquiring unit 142 and the omnidirectional TOF image data output from the TOF image data acquiring unit 144 to the display device 500.

Similar to the second modification illustrated in FIG. 12, the display device 500 illustrated in FIG. 20 includes a transmitter-receiver 510, a display unit 520, a display controller 530, a RGB image data acquiring unit 542, a monochrome processor 543, a TOF image data acquiring unit 544, a high resolution acquiring unit 545, a matching processor 546, a reprojection processor 547, a semantic segmentation unit 548, a parallax calculator 549, a three-dimensional reconstruction processor 550, and a determination unit 560.

The transmitter-receiver 180 receives the omnidirectional RGB image data and the omnidirectional TOF image data transmitted from the imaging device 1.

The RGB image data acquiring unit 542 acquires the omnidirectional RGB image data from the transmitter-receiver 180, and the TOF image data acquiring unit 544 acquires the omnidirectional RGB image data from the transmitter-receiver 180. The RGB image data acquiring unit 142 and the TOF image data acquiring unit 144 illustrated in FIG. 4 are configured in the same manner as the RGB image data acquiring unit 142 and the TOF image data acquiring unit 144, respectively.

The monochrome processor 543, the TOF image data acquiring unit 544, the high resolution acquiring unit 545, the matching processor 546, the reprojection processor 547, the semantic segmentation unit 548, the parallax calculator 549, the three-dimensional reconstruction processor 550, and the determination unit 560 are configured similar to the monochrome processor 143, the TOF image data acquiring unit 144, the resolution enhancer 145, the matching processor 146, the reprojection processor 147, the semantic segmentation unit 148, the parallax calculator 149, the three-dimensional reconstruction processor 150, and the determination unit 160 illustrated in FIG. 4.

The display controller 530 may acquire the omnidirectional RGB image data from the RGB image data acquiring unit 542 to display a two-dimensional image based on the acquired omnidirectional RGB image data on the display unit 520, and may acquire the omnidirectional three-dimensional data from the three-dimensional reconstruction processor 150 to display a three-dimensional image on the display unit 520.

The display controller 530 displays a display image including information representing the determination result acquired from the determination unit 160 and the two-dimensional image or the three-dimensional image.

As described above, the display device 500 includes a transmitter-receiver 510, which is an example of a receiver configured to receive an output of an imaging unit 11 configured to capture an image of an object, and an output of a distance information acquiring unit 13 configured to project light onto the object and receive the light reflected from the object; a determination unit 560 configured to determine whether or not there is a specific object based on both the output of the distance information acquiring unit 13 received by the transmitter-receiver 510 and the output of the imaging unit 11; and a display controller 530 configured to cause a display unit to present a different display according to the presence or absence of the specific object based on the determination result of the determination unit 560.

Examples of the specific object include a proximate object, a high reflection object, a distant object, a low reflection object and image blur area.

The display device 500 includes a display controller 530 configured to display, on a display unit 520, a display image including identification information for identifying a specific object and a three-dimensional image 3G determined by a three-dimensional reconstruction processor 550 based on the determination result by the determination unit 560 configured to determine whether or not there is a specific object based on both an output of the distance information acquiring unit 13 configured to project light on the object and receive light reflected from the object.

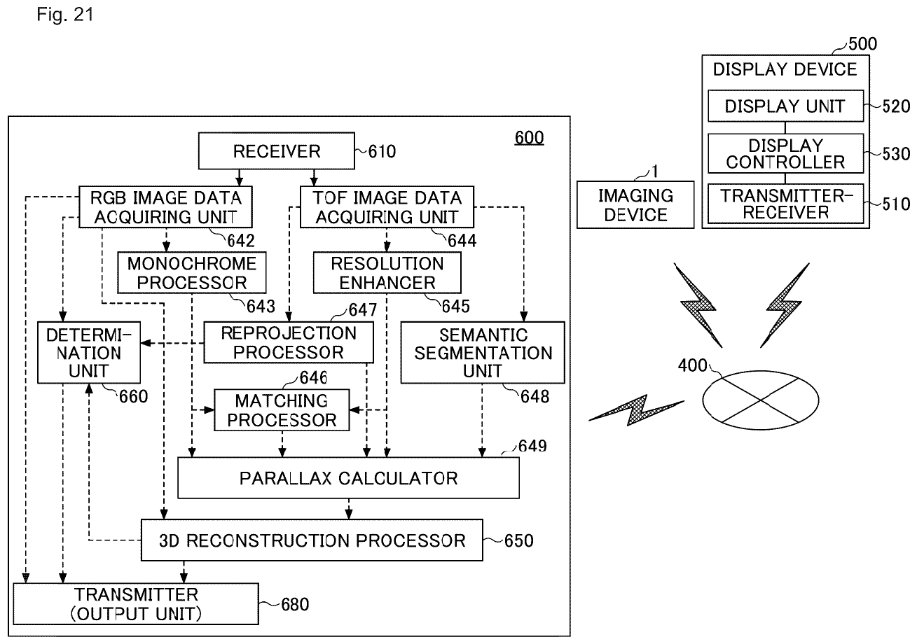

FIG. 21 is a diagram illustrating an example of a configuration of an information processing system according to a seventh modification of the embodiment of the present disclosure.

The information processing system according to the seventh modification illustrated in FIG. 21 includes an imaging device 1, a display device 500, and a server 600.

The imaging device 1 illustrated in FIG. 21 is configured similar to the imaging device 1 illustrated in FIG. 20, and the display device 500 illustrated in FIG. 21 is configured similar to the display device 500 illustrated in FIG. 12.

The server 600 illustrated in FIG. 21 includes a receiver 610, an RGB image data acquiring unit 642, a monochrome processor 643, a TOF image data acquiring unit 644, a resolution enhancer 645, a matching processor 646, a reprojection processor 647, a semantic segmentation unit 648, a parallax calculator 649, a three-dimensional reconstruction processor 650, a determination unit 660, and a transmitter 680.

The receiver 610 receives an omnidirectional RGB image data and an omnidirectional TOF image data transmitted from the imaging device 1 via the network 400.

The RGB image data acquiring unit 642 acquires the omnidirectional RGB image data from the receiver 610, and the TOF image data acquiring unit 644 acquires the omnidirectional RGB image data from the receiver 610. Other configurations of the RGB image data acquiring unit 642 and the TOF image data acquiring unit 644 are similar to those of the RGB image data acquiring unit 142 and the TOF image data acquiring unit 144 illustrated in FIG. 4.

The monochrome processor 643, the TOF image data acquiring unit 644, the resolution enhancer 645, the matching processor 646, the reprojection processor 647, the semantic segmentation unit 648, the parallax calculator 649, the three-dimensional reconstruction processor 650, and the determination unit 660 are configured in a similar manner as the monochrome processor 143, the TOF image data acquiring unit 144, the resolution enhancer 145, the matching processor 146, the reprojection processor 147, the semantic segmentation unit 148, the parallax calculator 149, the three-dimensional reconstruction processor 150, and the determination unit 160 illustrated in FIG. 4.

The transmitter 680 transmits (outputs) the omnidirectional three-dimensional data output from the three-dimensional reconstruction processor 150, the omnidirectional two-dimensional image information output from the RGB image data acquiring unit 142, and the determination result of the determination unit 160 to the display device 500 through the network 400.

The transmitter-receiver 510 of the display device 510 receives the omnidirectional three-dimensional data, the omnidirectional two-dimensional image information, and the determination result of the determination unit 160 transmitted from the server 600.

The display controller 530 of the display device 510 may acquire the omnidirectional RGB image data from the transmitter-receiver 510 to display a two-dimensional image based on the acquired omnidirectional RGB image data on the display unit 520, or may acquire the omnidirectional three-dimensional data from the transmitter-receiver 510 to display the three-dimensional image on the display unit 20.

The display controller 530 displays a display image including information representing the determination result acquired from the transmitter-receiver 510 and a two-dimensional image or a three-dimensional image to the display unit 520.

As described above, the display device 500 includes a transmitter-receiver 510 configured to receive a determination result by the determination unit 660 of the server 600, based on both the output of the imaging unit 11 configured to capture an image of an object and the output of the distance information acquiring unit 13 configured to project light and receive light reflected from the object, and the display controller 530 configured to cause the display unit 520 to present a different display according to the presence or absence of a specific object, based on the determination result received by the transmitter-receiver 510. Examples of the specific object include a proximate object, a high reflection object, a distant object, a low reflection object, and an image blur area.

The display device 500 includes a display controller 530 configured to display a display image to the display unit 520 including identification information for identifying a specific object and a three-dimensional image 3G determined by a three-dimensional reconstruction processor 650, based on a determination result of the determination unit 660 configured to determine whether a specific object is present based on both an output of the imaging unit 11 configured to capture an image of an object and an output of a distance information acquiring unit 13 configured to project light to an object and receiving light reflected from the object.

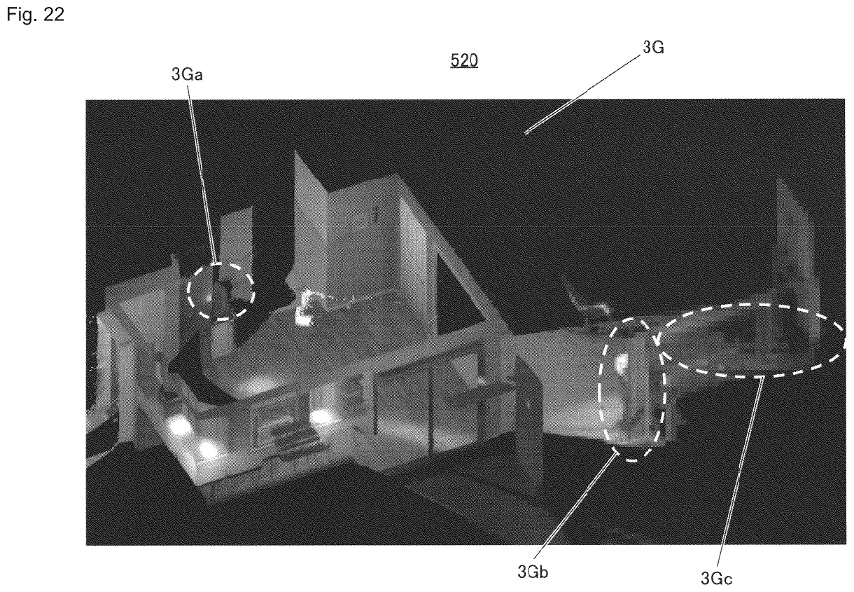

FIG. 22 is a diagram illustrating display contents of a display unit according to the fifth to seventh modifications.

As illustrated in FIG. 22, the display controller 530 the display controller 530 also displays a three-dimensional image 3G including identification information 3Ga, 3Gb and 3Gc for identifying a specific object on the display unit 520. The identification information 3Ga, 3Gb and 3Gc may be location identifying information identifying a position of a specific object.

FIG. 22 illustrates a display unit 520, but the display controller 170 also displays a three-dimensional image 3G including identification information 3Ga, 3Gb and 3Gc for identifying a specific object on the display unit 20.

Herein, the identification information 3Ga indicates a blind spot and is identified and displayed in pink or the like. The identification information 3Gb indicates a low reflection object and is identified and displayed in orange or the like. The identification information 3Gc indicates a distant object and is identified and displayed by a mosaic or the like.

All of the identification information 3Ga, 3Gb and 3Gc may be displayed at the same time, or any one or two of the identification information 3Ga, 3Gb and 3Gc may be displayed at the same time.

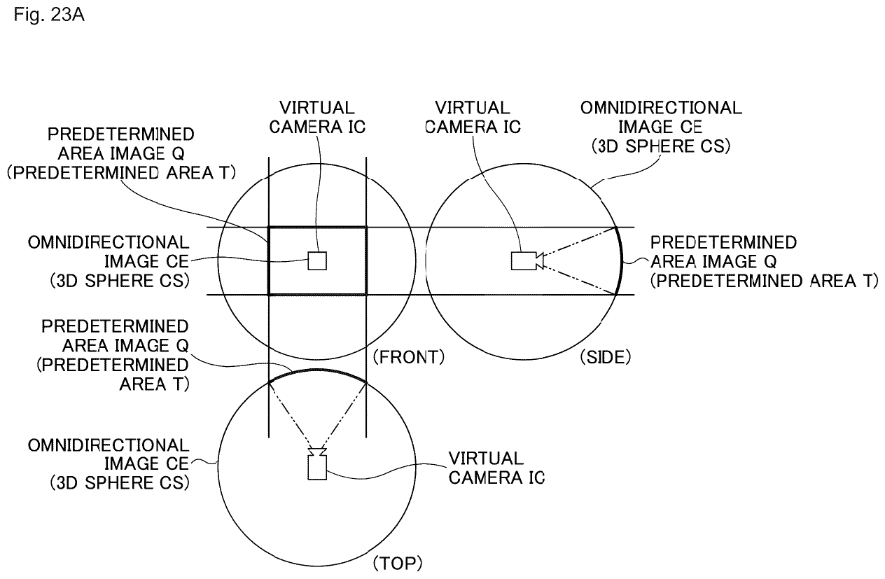

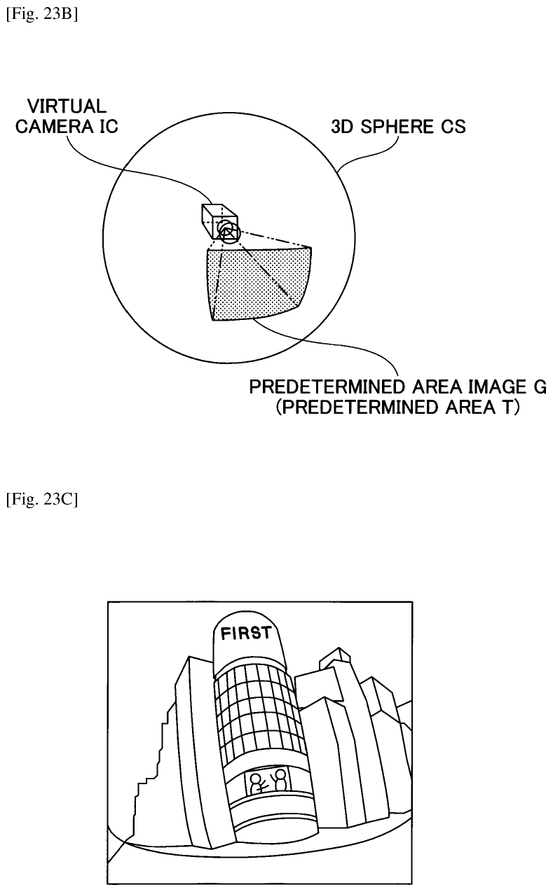

FIGS. 23A to 23C are diagrams illustrating a three-dimensional image displayed by a display unit according to the embodiments of the present disclosure.

FIG. 23A illustrates positions of a virtual camera and a predetermined area when an omnidirectional image is represented by a three-dimensional sphere.

The position of the virtual camera IC corresponds to a viewpoint of a user who views the omnidirectional image CE displayed as a three-dimensional sphere.

FIG. 23B illustrates a stereoscopic perspective view of FIG. 23A, and FIG. 23C illustrates a predetermined area image when displayed on a display.

FIG. 23B depicts the omnidirectional image CE illustrated in FIG. 23A as a three-dimensional sphere CS. When the generated omnidirectional image CE is a three-dimensional sphere CS, as illustrated in FIG. 23A, the virtual camera IC is located within the omnidirectional image CE.

The predetermined area T in the omnidirectional image CE is a shooting area of the virtual camera IC and is specified by predetermined area information representing a shooting direction and a field angle of the virtual camera IC in the three-dimensional virtual space including the omnidirectional image CE.

The zoom of the predetermined area T can be represented by moving the virtual camera IC close to or away from the omnidirectional image CE. A predetermined area image Q is an image of the predetermined area T in the omnidirectional image CE. Thus, the predetermined area T can be specified by the angle α and the distance f between the virtual camera IC and the omnidirectional image CE.

That is, the display controller 170 and 530 changes the display area of the three-dimensional image 3G to be displayed on the display unit 20 and 520 by changing the position and orientation of the virtual camera IC at the viewpoint of viewing the three-dimensional image 3G.

In the above, the three-dimensional image displayed by the display unit is described with reference to an example of an omnidirectional image; however, the same applies to a case using a three-dimensional point cloud data. A three-dimensional point cloud is arranged in a virtual space and a virtual camera is arranged in the virtual space. A three-dimensional image is obtained by projecting the three-dimensional point cloud on a predetermined projection plane in a virtual space based on predetermined area information representing a viewpoint position, a shooting direction, and an image angle of the virtual camera. The viewpoint position and orientation of the virtual camera are changed so as to change the display area of the three-dimensional image.

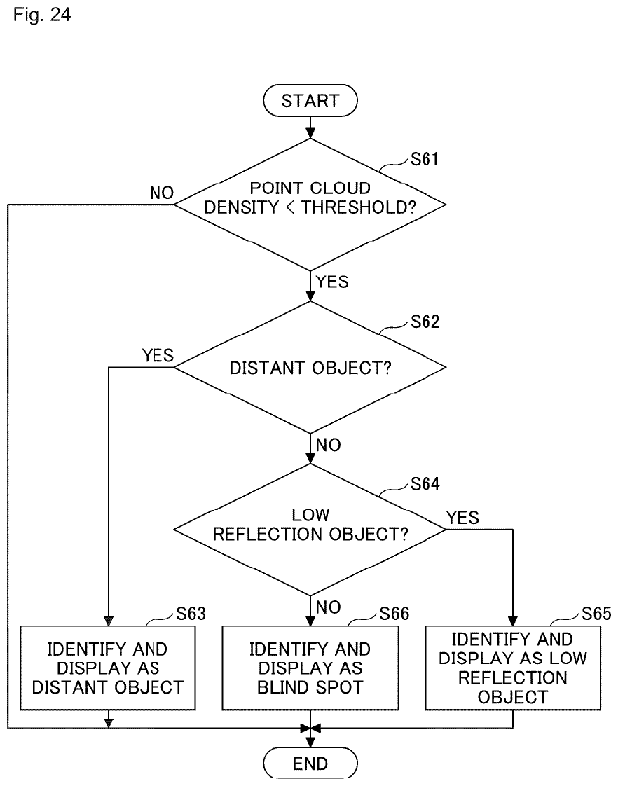

FIG. 24 is a flowchart illustrating a determination process according to the fifth to seventh modifications. In step S61, the determination units 160, 560, and 660 determine whether or not there is an area (coordinates) in which the density of the point cloud data is less than a threshold in the omnidirectional three-dimensional data (omnidirectional three-dimensional data) based on the omnidirectional three-dimensional data acquired from the three-dimensional reconstruction processors 150, 550, and 650.

In step S62, when the determination unit 160 determines in step S61 that there is an area (coordinates) in which the density of the point cloud data is less than the threshold, the determination units 160, 560, and 660 determine whether or not a plurality of pixels having the same coordinates as the area (coordinates) in which density of the point cloud data is less than the threshold include a pixel that is determined to be a distant object, based on the output of the imaging unit 11 in the flowchart illustrated in FIG. 16, and when a pixel that is determined to be a distant object is included, the coordinate position information of the pixel is output to the display controllers 170 and 530.

The display controllers 170 and 530 display a display image including position identification information 3Gc for identifying a position of a distant object and a three-dimensional image G on the display units 20 and 520 (step S63) based on coordinate position information of pixel acquired from the determination units 160, 560, and 660 and end the process, as illustrated in FIG. 22.

In step S64, when the plurality of pixels having the same coordinates as the area (coordinates) in which the density of the point cloud data is less than the threshold do not include a pixel that is determined to be a distant object in step S62, the determination units 160, 560, and 660 determine whether or not a pixel determined to be a low reflection object is included, based on the output of the imaging unit 11 in the flowchart illustrated in FIG. 16, and when a pixel determined to be a low reflection object is included, the coordinate position information of the pixel is output to the display controllers 170 and 530.

The display controllers 170 and 530 display a display image including position identification information 3Gb for identifying a position of a low reflection object and a three-dimensional image G on the display units 20 and 520 (step S65) based on coordinate position information of pixels acquired from the determination units 160, 560, and 660 and ends the process, as illustrated in FIG. 22.

In step S64, when a plurality of pixels having the same coordinates as the area in which the density of the point cloud data is less than the threshold do not include a pixel that is determined to include a low reflection object, the determination units 160, 560, and 660 determine the plurality of pixels that do not include such a pixel as being a blind spot, and output the coordinate position information on these pixels to the display controllers 170 and 530.

The display controllers 170 and 530 display a display image including position identification information 3Ga for identifying a position of the blind spot and a three-dimensional image G on the display units 20 and 520 (step S66), based on the coordinate position information of the pixels acquired from the determination units 160, 560, and 660 as illustrated in FIG. 22 and end the process. Steps S61, S62 and S64 are examples of the determination steps, and steps S63, S65 and S66 are examples of the display steps.

As described above, the imaging device 1 and the display device 500 include display controllers 170 and 530 configured to cause the display units 20 and 520 to present a different display on the display units 20 and 520. The display images include identification information 3Ga, 3Gb and 3Gc that identifies a specific object determined based on determination results of the determination units 160, 560, and 660, and three-dimensional image 3G determined by the three-dimensional reconstruction processors 150, 550, and 650. The determination units 160, 560, and 660 are configured to determine whether or not there is a specific object, based on both an output of the imaging unit 11 configured to capture an image of an object and an output of the distance information acquiring unit 13 configured to project light onto the object and receive light reflected from the object. The three-dimensional reconstruction processors 150, 550, and 650 are examples of the three-dimensional information determining unit, based on the output of the distance information acquiring unit 13.

Examples of the specific object include not only a distant object, a low reflection object and a blind spot, but also a proximate object, a high reflection object and an image blur area.

This enables a user to view the three-dimensional image 3G to identify the factor of not displaying the desired three-dimensional image 3G being any one of a distant object, a low reflection object, a blind spot, a proximate object, a high reflection object, and an image blur.

The imaging device 1 and the display device 500 include the display controllers 170 and 530 configured to display the three-dimensional image 3G, which is determined based on the output of the distance information acquiring unit 13 configured to receive light reflected from an object and is projected to the object, on the display controllers 170 and 530. The display controllers 170 and 530 display, on the display units 20 and 520, display images including position identification information 3Ga, 3Gb or 3Gc for identifying at least one of positions of a distant object, a low reflection object and a blind spot, and a three-dimensional image 3G, based on position information indicating a position determined to be at least one of the distant object, the low reflection object and the blind spot in the three dimensional image 3G, wherein the distant object is located away from the distance information acquiring unit 13 upon receiving light reflected from the object, the low reflection object has low reflectance with respect to projected light, and the blind spot is located relative to the distance information acquiring unit 13 upon receiving light reflected from the object.

This enables a user to view the three-dimensional image 3G to identify the factor of not displaying the desired three-dimensional image 3G being any one of a distant object, a low reflection object, or a blind spot, and to take measures such as reimaging the object according to the identified factor.

The three-dimensional image 3G is determined by the three-dimensional reconstruction processors 150, 550, and 650, which are examples of the three-dimensional information determination units.

The display controllers 170, 530 may display a display image including any one of position identification information 3Ga, 3Gb and 3Gc, and a three-dimensional image 3G on the display units 20 and 520 based on position information of any one of a distant object, a low reflection object, and a blind spot, and may display a display image including any two or all of position identification information 3Ga, 3Gb and 3Gc, and a three-dimensional image 3G on the display units 20 and 520, based on position information of any two or all of a distant object, a low reflection object, and a blind spot.

When the information processing device is the imaging device 1, the imaging device 1 includes a distance information acquiring unit 13 and a three-dimensional reconstruction processor 150 as illustrated in FIG. 19.

When the information processing device 500 is the display device 500, as illustrated in FIGS. 20 and 21, the display device 500 does not include a distance information acquiring unit 13, and the imaging device 1 includes a distance information acquiring unit 13 and transmits an output of the distance information acquiring unit 13 to the display device 500 or the server 600.

The display device 500 may or may not include a three-dimensional reconstruction processor 550 as illustrated in FIG. 20.

When the display device 500 does not include the three-dimensional reconstruction processor 550, the imaging device 1 may include the three-dimensional reconstruction processor 150 to transmit a three-dimensional image to the display device 500, or as illustrated in FIG. 21, the server 600 may include the three-dimensional reconstruction processor 650 to transmit the three-dimensional image to the display device 500.

The display controllers 170 and 530 display the display images including position identification information 3Ga, 3Gb and 3Gc, and the three-dimensional image 3G, based on position information indicating a position at which the density of the point cloud data included in the three-dimensional image 3G is less than the threshold and is determined to be at least one of a distant object, a low reflection object, or a blind spot.

This enables a user to view the three-dimensional image 3G to identify the factor of the density of the point cloud data to be less than the threshold being any one of a distant object, a low reflection object, or a blind spot.

The display controllers 170 and 530 display the display images including the position identification information 3Ga, 3Gb and 3Gc, and the three-dimensional image 3G, based on the position information representing a position determined to be at least one of a distant object, a low reflection object, or a blind spot in the three-dimensional image 3G based on the output of the imaging unit 11 configured to capture an image of an object.

This enables a user to accurately determine whether the factor of not displaying the desired three-dimensional image 3G is due to a distant object, a low reflection object, or a blind spot based on the output of the imaging unit 11.

When the information processing device is the imaging device 1, the imaging device 1 includes the imaging unit 11 as illustrated in FIG. 19. When the information processing device 500 is the display device 500, the display device 500 does not include the imaging unit 11 as illustrated in FIG. 20 and FIG. 21, and the imaging device 1 includes the imaging unit 11 to transmit the output of the imaging unit 11 to the display device 500 or the server 600.

The imaging device 1 and the display device 500 include the determination units 160, 560, and 660 configured to determine at least one of position of a distant object, a low reflection object, and a blind spot in the three-dimensional image 3G. The display controllers 170 and 530 display the display images including position identification information 3Ga, 3Gb and 3Gc, and a three-dimensional image 3G on the display units 20 and 520, based on the determination results of the determination units 160, 560, and 660.

When the information processing device is the imaging device 1, the imaging device 1 includes the determination unit 160 as illustrated in FIG. 19.

When the information processing device 500 is a display device 500, the display device 500 may include a determination unit 560 as illustrated in FIG. 20 or may not include a determination unit 560.

When the display device 500 does not include the determination unit 560, the imaging device 1 may include the determination unit 160 to transmit the determination result to the display device 500, or the server 600 may include the determination unit 660 as illustrated in FIG. 21 to transmit the determination result to the display device 500.

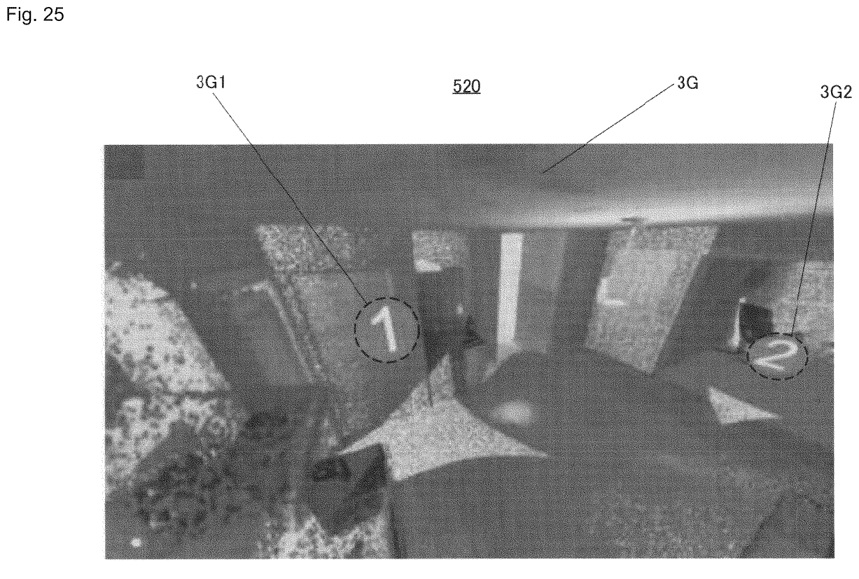

FIG. 25 is another diagram illustrating display contents of the display unit according to the fifth to seventh modifications.

As illustrated in FIG. 25, the display controller 530 displays a three-dimensional image 3G including position identification information 3G1 and 3G2 for identifying a position of the distance information acquiring unit 13 upon receiving light reflected from the object being displayed on the display unit 520.

The three-dimensional image 3G is determined based on an output of the distance information acquiring unit 13 located at a first position and an output of the distance information acquiring unit 13 located at a second position different from the first position. The position identification information 3G1 is an example of the first position identification information that identifies the first position, and the position identification information 3G2 is an example of the first position identification information that identifies the second position.

FIG. 25 illustrates the display unit 520, but the display controller 170 also displays on the display unit 20 the three-dimensional image 3G including position identification information 3G1 and 3G2 for identifying the position of the distance information acquiring unit 13 upon receiving light reflected from an object.

As illustrated in FIG. 22, the display controllers 170 and 530 display, on the display units 20 and 520, the display images including the three-dimensional image 3G and the identification information 3Ga, 3Gb and 3Gc, which are examples of the low density identification information. At the same time, as illustrated in FIG. 25, the display images may also include the position identification information 3G1 and 3G2 for identifying the position of the distance information acquiring unit 13 upon receiving light reflected from the object.

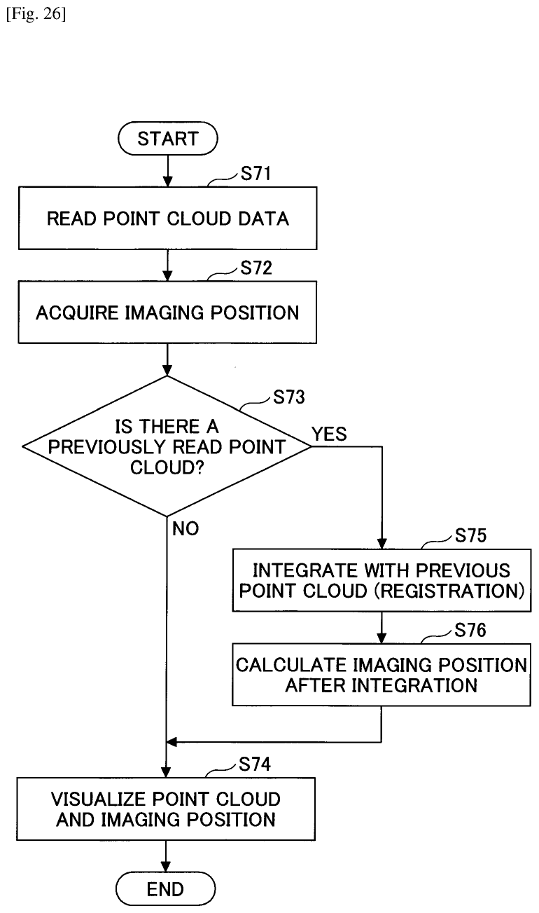

FIG. 26 is a flowchart illustrating a process according to the fifth to seventh modifications.

In step S72, the three-dimensional reconstruction processors 150, 550, and 650 read the high-density omnidirectional three-dimensional point cloud data (step S71) and acquire the origin of the three-dimensional point cloud data as position information indicating the imaging position of the distance information acquiring unit 13 upon receiving light reflected from the object.

In step S73, the three-dimensional reconstruction processors 150, 550, and 650 check whether there is a three-dimensional point cloud data read in advance. When there is no three-dimensional point cloud data read in advance, the three-dimensional point cloud data read in step S71 and the position information acquired in step S72 are output to the display controllers 170 and 530.

The display controllers 170 and 530 display, on the display units 20 and 520, a display image including position identification information 3G1 for identifying the position of the distance information acquiring unit 13 upon receiving light reflected from the object and the three-dimensional image 3G, based on the three-dimensional point cloud data and position information acquired from the three-dimensional reconstruction processors 150, 550, and 650, as illustrated in FIG. 25 (step S74), and ends the process.

In step S75, when there is a three-dimensional point cloud data read in advance in step S73, the three-dimensional reconstruction processors 150, 550, and 650 integrate the three-dimensional point cloud data read in step S71 with the previously read three-dimensional point cloud data.

In step S76, the three-dimensional reconstruction processors 150, 550, and 650 calculate the coordinates for each of the origin of the three-dimensional point cloud data read in step S71 and the origin of the previously read three-dimensional point cloud data in the three-dimensional point cloud data integrated in step S75, as the position information of the imaging position, and output the three-dimensional point cloud data integrated in step S75 and the calculated plurality of position information to the display controllers 170 and 530.

In step S74, the display controllers 170 and 530 display a display image including a plurality of position identification information 3G1 and 3G2 for identifying a position of the distance information acquiring unit 13 upon receiving light reflected from the object, and a three-dimensional image 3G, based on the three-dimensional point cloud data acquired from the three-dimensional reconstruction processors 150, 550, and 650 and a plurality of position information, as illustrated in FIG. 25.

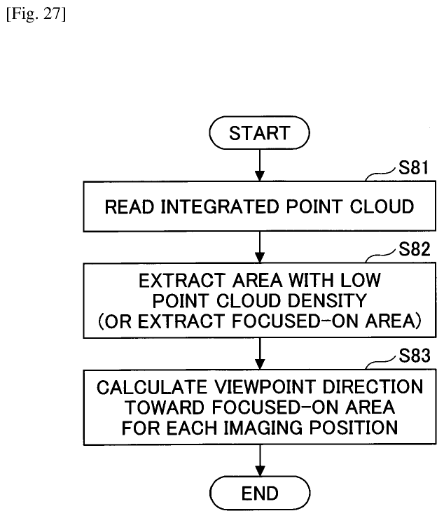

FIG. 27 is another flowchart illustrating a process according to the fifth to seventh modifications.

In step S82, the three-dimensional reconstruction processors 150, 550, and 650 read the high density omnidirectional three-dimensional point cloud data (step S81). In step S82, the determination units 160, 560, and 660 perform the steps S61, S62, and S64 of the flowchart illustrated in FIG. 24 based on the omnidirectional three-dimensional data acquired from the three-dimensional reconstruction processors 150, 550, and 650 to extract a low density portion where the density of the point cloud data is less than the threshold.

When the virtual camera IC illustrated in FIG. 23 is located at the position of the position identification information 3G1 or 3G2 illustrated in FIG. 25, the display controllers 170 and 530 execute the steps S63, S65, and S66 of the flowchart illustrated in FIG. 24 to change the orientation of the virtual camera IC so that at least one of the identification information 3Ga, 3Gb and 3Gc, which are an example of the low density identification information illustrated in FIG. 22, is included in the display image (step S83).

As described above, the imaging device 1 and the display device 500 include the display controllers 170 and 530 configured to display, on the display units 20 and 520, a three-dimensional image 3G determined based on an output of the distance information acquiring unit 13. The display controllers 170 and 530 display a display image including the position identification information 3G1 and 3G2 for identifying the position of the distance information acquiring unit 13 upon receiving light reflected from the object, and the three-dimensional image 3G on the display units 20 and 520, based on the position information representing the position of the distance information acquiring unit 13 upon receiving light reflected from the object.

This enables a user to identify a positional relationship between the position representing the position of the distance information acquiring unit 13 upon receiving light reflected from the object and the specific object in the three-dimensional image 3G.

The three-dimensional image 3G and position information are determined by the three-dimensional reconstruction processors 150, 550, and 650.

When the information processing device is the imaging device 1, the imaging device 1 includes the distance information acquiring unit 13 and a three-dimensional reconstruction processor 150 as illustrated in FIG. 19.

When the information processing device 500 is the display device 500, as illustrated in FIGS. 20 and 21, the display device 500 does not include the distance information acquiring unit 13, and the imaging device 1 includes the distance information acquiring unit 13 to transmit an output of the distance information acquiring unit 13 to the display device 500 or the server 600.

The display device 500 may or may not include the three-dimensional reconstruction processor 550 as illustrated in FIG. 20.

When the display device 500 does not include the three-dimensional reconstruction processor 550, the imaging device 1 may include the three-dimensional reconstruction processor 150 to transmit the three-dimensional image and position information to the display device 500, or the server 600 may include the three-dimensional reconstruction processor 650 to transmit the three-dimensional image and position information to the display device 500 as illustrated in FIG. 21.

The display controllers 170 and 530 display the display images including the identification information 3Ga, 3Gb and 3Gc, which are an example of the low-density identification information for identifying an area, and the three-dimensional image 3G, based on the area information representing the area in which the density of the point cloud data in the three-dimensional image 3G is less than the threshold.

In this case, the positional relationship between the imaging position and the area in which the density of the point cloud data is less than the threshold can be identified. Thus, it is possible to identify the factor that the density of the point cloud data is less than the threshold. For example, if the area is far from the imaging position, a distant object can be identified as the factor. If the area is in the blind spot of the imaging position, the blind spot can be identified as the factor. If the area is neither a distant object nor a blind spot, a low reflection object can be identified as the factor.

The display controllers 170 and 530 changes the display area of the three-dimensional image 3G to be displayed on the display unit 20 and 520 by changing the position and orientation of the virtual camera IC at the viewpoint of viewing the three-dimensional image 3G.

The display controllers 170 and 530 change the orientation of the virtual camera IC to a predetermined orientation when the position of the virtual camera IC is located at a position identified by the position identification information 3G1 or 3G2. The predetermined orientation covers the displayed area including a portion that causes reimaging, such as a low-density point cloud area, a portion that meets a predetermined condition, such as a checking portion of the on-site investigation, or any portion that is focused on by the photographer or other checker. Examples of portions to be checked in the construction site include: the location where changes are continuously occurring at the site (material stockyard), the location of each object in the main building (the building itself), the gap distance between the objects, the space for new installations, temporary installations (the stockyard, scaffolding, etc., which are removed from the construction process), the storage space for heavy machinery (forks, cranes), the work space (the range of rotation, the entry route), and the movement line of residents (bypass circuit during construction).

This enables the user's line of sight at the imaging position to be directed to a specific object that is desired to be viewed at the site.

The display controllers 170 and 530 change the orientation of the virtual camera IC so that the display area includes a low density portion in which the density of the predetermined coordinates or the point cloud data in the three-dimensional image 3G is less than the threshold. The predetermined coordinates do not specify the image, but are maintained, for example, when the image in the predetermined coordinates changes before and after integrating the three-dimensional point cloud data in step S75 of FIG. 26.

This enables the user's line of sight at the imaging position to be directed to a specific object that is represented by a low density portion in the three dimensional image 3G.

The display controllers 170 and 530 display, on the display units 20 and 520, the three-dimensional image 3G determined based on the output of the distance information acquiring unit 13 located at the first position and the output of the distance information acquiring unit 13 located at a second position different from the first position, and also display, on the display units 20 and 520, a display image including the first position identification information 3G1 and the second position identification information 3G2 for identifying the first position, and the three-dimensional image 3G.

This enables a user to identify the positional relationship between the first and second imaging positions and a specific object in the three-dimensional image 3G.

Summary

As described above, the imaging device 1 according to embodiments of the present disclosure includes an imaging unit 11 configured to capture an image of an object, a projector 12 configured to project light onto the object, a distance information acquiring unit 13 configured to receive light reflected from the object (an example of a light receiver), a determination unit 160 configured to determine whether a high reflection object is present based on both an output of the distance information acquiring unit 13 and an output of the imaging unit 11, and a display controller 170 configured to cause the display units 20 and 520 to present different displays according to the presence or absence of a high reflection object.

This enables the photographer to accurately identify that a high reflection object, such as a mirror, is included in the captured image, as distinguished from the effect of a proximate object or external light.

The imaging device 1 includes a display unit 20. This enables the photographer to identify that a high reflection object is included in the captured image.

The display controller 170 causes the display units 20 and 520 to present different displays according to a position of the high reflection object. This enables the photographer to identify the position of the high reflection object.

The display unit 20 includes a plurality of display units 20A and 20a, and the display controller 170 causes one of the display units 20A and 20a that is located closer to the high reflection object to display a display image different from a display image of the other one of the display units 20A and 20a according to the presence or absence of an object. This enables the photographer to reliably identify a position of the high reflection object.

The display controller 170 displays image information G captured by the imaging unit 11 on the display units 20 and 520 and displays a display image including identification information for identifying a high reflection object and the image information G on the display units 20 and 520. This enables the photographer to reliably identify a position of the high reflection object.

The determination unit 160 determines that there is a high reflection object when a charged amount in a pixel is saturated, as an example of a pixel whose charged amount by light received by the distance information acquiring unit 13 is equal to or greater than a predetermined value, and image information captured by the imaging unit is matched with model image information, as an example of reference information representing a high reflection object.

This enables the photographer to accurately identify that a high reflection object is included in the captured image, as distinguished from the effect of a proximate object or external light.

The imaging device 1 acquires distance information to an object based on light received by the distance information acquiring unit 13. In this case, the photographer can identify that the factor of not acquiring the desired distance information is not a proximate object or external light but a high reflection object.

The imaging device 1 includes a transmitter-receiver 180 as an example of an output unit configured to output three-dimensional information determined based on distance information acquired from the distance information acquiring unit 13. In this case, the photographer can identify that the factor of not acquiring the desired three-dimensional information is not a proximate object or external light but a high reflection object.

The image processing method according to the embodiments of the present disclosure includes: an imaging step of imaging an object by the imaging unit 11; a projection step of projecting light onto the object by the projector 12; a light receiving step of receiving light reflected from the object by the distance information acquiring unit 13; a determination step of determining by the determination units 160, 560, and 660 whether there is a high reflection object based on both an output of the distance information acquiring unit 13 and an output of the imaging unit 11; and a display step of causing the display units 20 and 520 to present different displays by the display controllers 170 and 530, according to the presence or absence of at least one of the high reflection object, the low reflection object, the distant object, or the image blur.

The imaging device 1 and the display device 500, which is an example of an information processing device according to the embodiments of the present disclosure, includes the display controllers 170 and 530 configured to cause the display units 20 and 520 to present different displays according to the presence or absence of a high reflection object based on determination results of the determination units 160, 560, and 660 configured to determine whether or not a high reflection object is present based on both an output of the imaging unit 11 configured to capture an image of an object and an output of the distance information acquiring unit 13 configured to project light onto the object and receive light reflected from the object.

The display device 500, which is an example of an information processing device according to the embodiments of the present disclosure, includes a transmitter-receiver 510 as an example of a receiver configured to receive a determination result from a determination unit 160 of the imaging device 1 or a determination unit 660 of the server 600, which is configured to determine whether there is a specific object, based on both an output of the imaging unit 11 configured to capture an image of an object and an output of a distance information acquiring unit 13 configured to project light and receive light reflected from the object, and a display controller 530 configured to cause the display unit 520 to present a different display based on a determination result received by the transmitter-receiver 510 according to the presence or absence of a specific object. Examples of the specific object include a proximate object, a high reflection object, a distant object, a low reflection object, a blind spot and an image blur area.

The display device 500, which is an example of an information processing device according to the embodiments of the present disclosure includes: a transmitter-receiver 510, as an example of a receiver, configured to receive an output of an imaging unit 11 configured to capture an image of an object and an output of a distance information acquiring unit 13 configured to project light on the object and receive light reflected from the object; a determination unit 560 configured to determine whether there is a specific object based on both the output of the distance information acquiring unit 13 received by the transmitter-receiver 510 and the output of the imaging unit 11; and a display controller 530 configured to cause the display unit to present a different display based on a determination result of the determination unit 560 according to the presence or absence of a specific object. Examples of the specific object include a proximate object, a high reflection object, a distant object, a low reflection object, a blind spot and an image blur area.

The imaging device 1 and the display device 500, which is an example of an information processing device according to the embodiments of the present disclosure, include the display controllers 170 and 530 configured to display a display image including identification information 3Ga, 3Gb and 3Gc for identifying a specific object, and a three-dimensional image 3G on the display units 20 and 520, based on determination results of the determination units 160 and 560 configured to determine whether a specific object is present based on both the output of the imaging unit 11 configured to capture an image of an object and the output of the distance information acquiring unit 13 configured to project light onto the object and receive light reflected from the object. Examples of the specific object include not only a distant object, a low reflection object and a blind spot, but also a proximate object, a high reflection object and an image blur area.

The three-dimensional image 3G is determined, based on the output of the distance information acquiring unit 13, by the three-dimensional reconstruction processors 150, 550, and 650, which are examples of the three-dimensional information determination unit.

This enables a user to view the three-dimensional image 3G to identify the factor of not displaying the desired three-dimensional image 3G being any one of a distant object, a low reflection object, a blind spot, a proximate object, a high reflection object, and an image blur.

The imaging device 1 and the display device 500, which is an example of an information processing device according to the embodiments of the present disclosure, include the display controllers 170 and 530 configured to display, on the display units 20 and 520, a display image including position identification information for identifying a position based on position information representing a position determined, by the determination units 160 and 560, according to whether the output of the distance information acquiring unit 13 configured to project light onto an object and receive light reflected from the object is equal to or less than the threshold, and two-dimensional image G imaged by the imaging unit 11 configured to capture an image of an object.

This enables a user to identify a factor of not obtaining a desired output by identifying, from the two-dimensional image information G, a position at which the output of the distance information acquiring unit 13 is equal to or less than the threshold, i.e., a position at which the desired output cannot be obtained due to the output of the distance information acquiring unit 13 being too strong or too weak.

The imaging device 1 and a display device 500, which is an example of an information processing device according to the embodiments of the present disclosure, include display controllers 170 and 530 configured to display, on the display units 20 and 520, a display image including position identification information for identifying a position based on position information representing a position determined by the determination units 160 and 560 at which distance information to an object cannot be acquired based on an output of a distance information acquiring unit 13 configured to project light onto an object and receive light reflected from the object, and two-dimensional image G captured by the imaging unit 11 configured to capture an image of an object.

This enables a user to identify a position, at which the distance information to the object cannot be acquired, with the two-dimensional image G, so as to identify a factor of not acquiring the distance information to the object.

The determination units 160, 560, and 660 determine that the distance to the object information cannot be acquired by not only when the output of the distance information acquiring unit 13 is equal to or greater than the threshold but also when an image blur is detected by the output of the distance information acquiring unit 13.

As described above, when the information processing device is the imaging device 1, the imaging device 1 includes the imaging unit 11, the distance information acquiring unit 13, the three-dimensional reconstruction processor 150, and the determination unit 160 as illustrated in FIG. 19.

When the information processing device 500 is the display device 500, as illustrated in FIGS. 20 and 21, the display device 500 does not include the imaging unit 11 and the distance information acquiring unit 13, and the imaging device 1 includes the imaging unit 11 and the distance information acquiring unit 13, and transmits these outputs of the imaging unit 11 and the distance information acquiring unit 13 to the display device 500 or the server 600.

The display device 500 may or may not include a determination unit 560 as illustrated in FIG. 20.

When the display device 500 does not include the determination unit 560, the imaging device 1 may include the determination unit 160 to transmit a determination result to the display device 500, or the server 600 may include the determination unit 660 as illustrated in FIG. 21 to transmit a determination result to the display device 500.

Similarly, the display device 500 may or may not include the three-dimensional reconstruction processor 550 as illustrated in FIG. 20.

When the display device 500 does not include the three-dimensional reconstruction processor 550, the imaging device 1 may include the three-dimensional reconstruction processor 150 to transmit the three-dimensional image to the display device 500, or the server 600 may include the three-dimensional reconstruction processor 650 to transmit the three-dimensional image to the display device 500 as illustrated in FIG. 21.

As described above, the imaging device 1 according to the embodiments of the present disclosure includes the imaging unit 11 configured to capture an image of an object, a projector 12 configured to project light onto the object, a distance information acquiring unit 13 configured to receive light reflected from the object (an example of a light receiver), a determination unit 160 configured to determine whether there is a distant object or a low reflection object, based on both an output of the distance information acquiring unit 13 and an output of the imaging unit 11, and a display controller 170 configured to cause the display units 20 and 520 to present different displays according to the presence or absence of a distant object or a low reflection object.

This enables the photographer to accurately identify that a distant object or a low reflection object, such as of black color, is included in the captured image.

The imaging device 1 includes the display unit 20. This enables the photographer to reliably identify that a distant object or a low reflection object is included in the captured image.

The display controller 170 causes the display units 20 and 520 to present different displays according to the position of the distant object or the low reflection object. This enables the photographer to identify a position of a distant object or a low reflection object.

The display unit 20 includes a plurality of display units 20A and 20a, and the display controller 170 causes one of a plurality of display units 20A and 20a that is closer to a distant object or a low reflection object to display a different display according to the presence or absence of an object. This enables the photographer to reliably identify a position of a distant object or a low reflection object.

The display controller 170 displays image information G captured by the imaging unit 11 on the display units 20 and 520, and displays, on display units 20 and 520, a display image including identification information for identifying a distant object or a low reflection object and image information G. This enables the photographer to reliably identify a position of a distant object or a low reflection object.

When the charged amount in a pixel by light received by the distance information acquiring unit 13 is equal to or less than a threshold, the determination unit 160 determines whether the pixel represents a low reflection object or a distant object based on the output of the imaging unit 11. This enables the photographer to accurately identify whether a low reflection object or a distant object is included in the captured image.

When the charged amount in a pixel by light received by the distance information acquiring unit 13 is equal to or less than the threshold and the charged amount in the pixel of the imaging unit 11 is equal to or less than the threshold, the determination unit 160 determines that there is a low reflection object. This enables the photographer to accurately identify that a low reflection object is included in the captured image.

The determination unit 160 determines that there is a distant object when the charged amount in a pixel by light received by the distance information acquiring unit 13 is equal to or less than the threshold, the charged amount in a pixel of the imaging unit 11 is equal to or greater than the threshold, and the distance determined based on a pixel is equal to or greater than the threshold.

This enables the photographer to accurately identify that a distant object is included in the captured image.

The imaging device 1 acquires distance information to an object based on light received by the distance information acquiring unit 13. In this case, the photographer can identify that the factor of not acquiring the desired distance information is a distant object or a low reflection object.

The imaging device 1 includes a transmitter-receiver 180 as an example of an output unit configured to output three-dimensional information determined based on distance information acquired from the distance information acquiring unit 13. In this case, the photographer can identify that the factor of not acquiring the desired three-dimensional information is a distant object or a low reflection object.

The image processing method according to the embodiments of the present disclosure includes: an imaging step of imaging an object by the imaging unit 11; a projection step of projecting light onto the object by the projector 12; a light receiving step of receiving light reflected from the object by the distance information acquiring unit 13; a determination step of determining whether there is a distant object or a low reflection object by the determination unit 160, 560, and 660, based on both an output of the distance information acquiring unit 13 and an output of the imaging unit 11; and a display step of causing the display units 20 and 520 to present different displays by the display controllers 170 and 530, according to the presence or absence of a distant object or a low reflection object.

The imaging device 1 and a display device 500, which is an example of an information processing device according to the embodiments of the present disclosure, include display controllers 170 and 530 configured to cause display units 20 and 520 to present different displays according to the presence or absence of a distant object or a low reflection object, based on a determination result of determining whether a distant object or a low reflection object is present based on both an output of the imaging unit 11 configured to capture an image of an object and an output of the distance information acquiring unit 13 configured to project light onto the object and receive light reflected from the object.

As described above, the imaging device 1 according to the embodiments of the present disclosure includes an imaging unit 11 configured to capture an image of an object, a projector 12 configured to project light onto the object, a distance information acquiring unit 13 configured to receive light reflected from the object (an example of a light receiver), a determination unit 160 configured to determine whether an image blur is present based on both an output of the distance information acquiring unit 13 and an output of the imaging unit 11, and a display controller 170 configured to cause the display units 20 and 520 to present different displays according to whether or not an image blur is present.

This enables the photographer to accurately identify that an image blur is included in the captured image.

The imaging device 1 includes a display unit 20. This enables the photographer to accurately identify that an image blur is included in the captured image.

The display controller 170 causes the display units 20 and 520 to present different displays according to the position of the image blur. This enables the photographer to check the position of the image blur.

The display unit 20 includes a plurality of display units 20A and 20a, and the display controller 170 causes one of the display units 20A and 20a located closer to the position of an image blur to display a different display, according to the presence or absence of an object. This enables the photographer to accurately identify that an image blur is included in the captured image.

The display controller 170 displays the image information G imaged by the imaging unit 11 on the display units 20 and 520, and displays a display image including identification information for identifying an image blur and the image information G on the display units 20 and 520. This enables the photographer to accurately identify that an image blur is included in the captured image.

The determination unit 160 detects an edge of an image based on image information captured by the imaging unit 11, and determines that there is an image blur when the pixel shift caused by light received by the distance information acquiring unit 13.

This enables the photographer to accurately identify that an image blur is included in the captured image.

The imaging device 1 acquires distance information to an object based on the light received by the distance information acquiring unit 13. In this case, the photographer can identify that the factor of not acquiring the desired distance information is an image blur.

The imaging device 1 includes a transmitter-receiver 180 as an example of an output unit configured to output three-dimensional information determined based on distance information acquired from the distance information acquiring unit 13. In this case, the photographer can identify that the factor of not acquiring the desired three-dimensional information is an image blur.

The image processing method according to an embodiment of the present disclosure includes: an imaging step of imaging an object by the imaging unit 11; a projection step of projecting light to the object by the projector 12; a light receiving step of receiving light reflected from the object by the distance information acquiring unit 13; a determination step of determining whether an image blur is present based on both an output of the distance information acquiring unit 13 and an output of the imaging unit 11 by the determination units 160, 560, and 660; and a display step of causing the display units 20 and 520 to present different displays by the display controllers 170 and 530 according to whether or not an image blur is present.

The imaging device 1 and a display device 500, which is an example of an information processing device according to the embodiments of the present disclosure, include the display controllers 170 and 530 configured to cause the display units 20 and 520 to present different displays according to the presence or absence of image blur based on the determination results of the determination units 160, 560, and 660 configured to determine whether there is an image blur based on both the output of the imaging unit 11 configured to capture an image of an object and the output of the distance information acquiring unit 13 configured to project light onto the object and receive light reflected from the object.

The imaging device 1 and the display device 500, which is an example of an information processing device according to the embodiments of the present disclosure, include the display controllers 170 and 530 configured to display a three-dimensional image 3G determined based on an output of the distance information acquiring unit 13, as an example of a light receiver, configured to project light onto an object and receive light reflected from the object. The display controllers 170 and 530 display a display image including position identification information 3Ga, 3Gb and 3Gc for identifying at least one position of a distant object, a low reflection object, and a blind spot, and a three-dimensional image 3G on the display units 20 and 520, where the position identification information 3Ga, 3Gb and 3Gc is determined based on the position information indicating the position that is determined to be at least one of a distant object located away from the distance information acquiring unit 13 upon receiving light reflected from the object, a low reflection object with low reflectance to projected light, and a blind spot to the distance information acquiring unit 13 upon receiving light reflected from the object, in the three-dimensional image 3G.

This enables a user to view the three-dimensional image 3G to identify the factor of not displaying the desired three-dimensional image 3G being any one of a distant object, a low reflection object, or a blind spot, and to take measures such as imaging the object according to the identified factor.

The three-dimensional image 3G is determined by the three-dimensional reconstruction processors 150, 550, and 650, which are examples of the three-dimensional information determination unit.

The display controllers 170, 530 may display a display image including any one of position identification information 3Ga, 3Gb and 3Gc, and a three-dimensional image 3G on the display units 20 and 520 based on position information of any one of a distant object, a low reflection object, and a blind spot, and may display a display image including any two or all of position identification information 3Ga, 3Gb and 3Gc, and a three-dimensional image 3G on the display units 20 and 520, based on position information of any two or all of a distant object, a low reflection object, and a blind spot.

When the information processing device is the imaging device 1, the imaging device 1 includes a distance information acquiring unit 13 and a three-dimensional reconstruction processor 150 as illustrated in FIG. 19.

When the information processing device 500 is a display device 500, as illustrated in FIGS. 20 and 21, the display device 500 does not include a distance information acquiring unit 13, and the imaging device 1 includes a distance information acquiring unit 13 to transmit an output of the distance information acquiring unit 13 to the display device 500 or the server 600.

The display device 500 may or may not include a three-dimensional reconstruction processor 550. When the display device 500 does not include a three-dimensional reconstruction processor 550, the imaging device 1 may include a three-dimensional reconstruction processor 150 to transmit a three-dimensional image to the display device 500. As illustrated in FIG. 21, the server 600 may include a three-dimensional reconstruction processor 650 to transmit a three-dimensional image to the display device 500.

The display controllers 170 and 530 display the display images including position identification information 3Ga, 3Gb and 3Gc, and the three-dimensional image 3G based on position information indicating a position where the density of the point cloud data included in the three-dimensional image 3G is less than the threshold and is determined to be at least one of a distant object, a low reflection object, or a blind spot.

This enables a user to view the three-dimensional image 3G to identify the factor of the density of the point cloud data to be less than the threshold being any one of a distant object, a low reflection object, or a blind spot.

The display controllers 170 and 530 display the display images including the position identification information 3Ga, 3Gb and 3Gc, and the three-dimensional image 3G, based on the position information representing a position determined to be at least one of a distant object, a low reflection object, or a blind spot in the three-dimensional image 3G based on the output of the imaging unit 11 configured to capture an image of an object.

This enables a user to identify whether a factor of not displaying a desired three-dimensional image 3G is one of a distant object, a low reflection object, and a blind spot based on the output of the imaging unit 11.

When the information processing device is the imaging device 1, the imaging device 1 includes the imaging unit 11 as illustrated in FIG. 19. When the information processing device 500 is the display device 500, the display device 500 does not include the imaging unit 11 as illustrated in FIG. 20 and FIG. 21, and the imaging device 1 includes the imaging unit 11 to transmit the output of the imaging unit 11 to the display device 500 or the server 600.

The imaging device 1 and the display device 500 include the determining units 160 and 560 configured to determine the position of at least one of a distant object, a low reflection object, or a blind spot in the three-dimensional image 3G. The display controllers 170 and 530 display, on the display units 20 and 520, a display image including the position identification information 3Ga, 3Gb and 3Gc, and the three-dimensional image 3G, based on the determination results of the determining units 160 and 560.

When the information processing device is the imaging device 1, the imaging device 1 includes a determination unit 160 as illustrated in FIG. 19.

When the information processing device 500 is the display device 500, the display device 500 may include a determination unit 560 and a determination unit 560 as illustrated in FIG. 20.

When the display device 500 does not include the determination unit 560, the imaging device 1 may include the determination unit 160 to transmit the determination result to the display device 500, or the server 600 may include the determination unit 660 to transmit the determination result to the display device 500 as illustrated in FIG. 21.

The display controllers 170 and 530 changes the display area of the three-dimensional image 3G to be displayed on the display unit 20 and 520 by changing the position and orientation of the virtual camera IC at the viewpoint of viewing the three-dimensional image 3G.

The imaging device 1 and a display device 500, which is an example of an information processing device according to the embodiments of the present disclosure, include display controllers 170 and 530 configured to display a three-dimensional image 3G determined based on an output of a distance information acquiring unit 13 as an example of a light receiver configured to project light onto an object and receive light reflected from the object. The display controllers 170 and 530 display a display image including position identification information 3G1 and 3G2 for identifying a position of the distance information acquiring unit 13 upon receiving light reflected from the object, based on position information indicating a position of the distance information acquiring unit 13 upon receiving light reflected from the object, and a three-dimensional image 3G.

This enables a user to identify a positional relationship between the position representing the position of the distance information acquiring unit 13 upon receiving light reflected from the object and the specific object in the three-dimensional image 3G. That is, it is easy to compare the positional relationship between the imaging position at the site where the three-dimensional image is acquired and the specific object, and the positional relationship between the imaging position in the three-dimensional image and the specific object.

The three-dimensional image 3G and the position information are determined by the three-dimensional reconstruction processors 150, 550, and 650, which are examples of the three-dimensional information determination units.

When the information processing device is the imaging device 1, the imaging device 1 includes a distance information acquiring unit 13 and a three-dimensional reconstruction processor 150.

When the information processing device 500 is a display device 500, the display device 500 does not include a distance information acquiring unit 13, and the imaging device 1 transmits the output of the distance information acquiring unit 13 to the display device 500 or the server 600.

The display device 500 may or may not include a three-dimensional reconstruction processor 550, and when the display device 500 does not include a three-dimensional reconstruction processor 550, the imaging device 1 may include a three-dimensional reconstruction processor 150 to transmit a three-dimensional image and position information to the display device 500, and the server 600 may transmit a three-dimensional image and position information to the display device 500 with a three-dimensional reconstruction processor 650.

The display controllers 170 and 530 display the display images including the identification information 3Ga, 3Gb and 3Gc, which are an example of the low-density identification information for identifying an area based on area information representing the area in which density of the point cloud data in the three-dimensional image 3G is less than the threshold, and the three-dimensional image 3G.

In this case, the positional relationship between the imaging position and the area in which the density of the point cloud data is less than the threshold can be identified, it is possible to specify a factor where the density of the point cloud data is less than the threshold. For example, it can be specified that a distant object is the cause when the area is more distant than the imaging position, a blind spot is the cause when the area is at a blind spot of the imaging position, and a low reflection object is the cause when the area is not at a distance or a blind spot.

The display control controllers 170 and 530 changes the display area of the three-dimensional image 3G to be displayed on the display unit 20 and 520 by changing the position and orientation of the virtual camera IC at the viewpoint of viewing the three-dimensional image 3G.

The display controllers 170 and 530 change the orientation of the virtual camera IC to a predetermined orientation when the position of the virtual camera IC is at a position identified by the position identification information 3G1 or 3G2.

This enables the user's line of sight at the imaging position to be directed toward a specific object that is desired to be viewed at the site.

The display controllers 170 and 530 change the orientation of the virtual camera IC so that a display area includes predetermined coordinates and a low density portion in which the density of the point cloud data in the three-dimensional image 3G is less than the threshold.

This enables the user's line of sight located at the imaging position to be directed toward predetermined coordinates or toward a specific object that is represented by a low density portion in the three-dimensional image 3G.

The display controllers 170 and 530 display the three-dimensional image 3G determined based on an output of the distance information acquiring unit 13 located at a first position and an output of the distance information acquiring unit 13 located at a second position different from the first position, and display a display image including first position identification information 3G1 for identifying the first position and second position identification information 3G2 for identifying the second position, and the three-dimensional image 3G on the display units 20 and 520.

Thus, the positional relationship between the first and second imaging positions and a specific object can be identified in the three-dimensional image 3G.

### REFERENCE SIGNS LIST

1 imaging device (an example of information processing device)
3G three dimensional image
3Ga, 3Gb, 3Gc identification information
3G1, 3G2 location identification information
10 housing
11 imaging unit
11a, 11A image sensor element
11b, 11B fisheye lens
12 projector
12a, 12A light source unit
12b, 12B wide-angle lens
13 distance information acquiring unit (example of light receiving unit)
13a, 13A TOF sensor
13b, 13B wide-angle lens
14 processing circuit
15 shooting switch
20 display unit
20A, 20a display unit
111 another imaging unit
141 controller
142 RGB image data acquiring unit
143 monochrome processor
144 TOF image data acquiring unit
145 resolution enhancer
146, 546, 646 matching processor
147 reprojection processor
148, 548 semantic segmentation unit
149 parallax calculator
150, 550, 650 three-dimensional reconstruction processor (an example of three-dimensional information determination unit)
160, 560, 660 determination unit
170 display controller (example of output unit)
180 transmitter-receiver (example of output unit)
300 external device (example of output destination)
500 display device (example of output destination, information processing device)
510 transmitter-receiver
520 display unit (example of output destination)
530 display controller (example of output unit)
600 server
L synchronization signal line
   The present application is based on and claims the benefit of priorities of Japanese Priority Application No. 2021-048195 filed on Mar. 23, 2021, Japanese Priority Application No. 2021-048022 filed on Mar. 23, 2021, and Japanese Priority Application No. 2021-048028 filed on Mar. 23, 2021, the contents of which are incorporated herein by reference.

1. An imaging device, comprising:
an imager to capture an image of an object;
a projector to project light onto the object;
a light receiver to receive light reflected from the object;
determination circuitry configured to determine whether a presence or absence of at least one of a high reflection object, a low reflection object, a distant object, or an image blur, based on both an output of the light receiver and an output of the imager; and
a display controller configured to cause a display to present a different display according to the presence or absence of at least one of the high reflection object, the low reflection object, the distant object, or the image blur.

2. The imaging device according to claim 1, wherein:
the display controller displays a display image on the display, the display image including information on an image captured by the imager, and identification information for identifying at least one of the high reflection object, the low reflection object, the distant object, and the image blur.

3. The imaging device according to claim 1, further comprising:
the display.

4. The imaging device according to claim 1, wherein:
the display controller causes the different display at a position of the display according to a position of at least one of the high reflection object, the low reflection object, the distant object, and the image blur.

5. The imaging device according to claim 1, wherein:
the display includes a plurality of displays, and
the display controller causes one of the displays that is located closer to the high reflection object to present a different display according to the presence or absence of at least one of the high reflection object, the low reflection object, the distant object, and the image blur.

6. The imaging device according to claim 1, wherein:
when a charged amount in a pixel by light received by the light receiver is equal to or greater than a predetermined value, and information on the image captured by the imager is matched with reference information representing the high reflection object, the determination circuitry determines that the high reflection object is present.

7. The imaging device according to claim 1, wherein:
when a charged amount in a pixel by light received by the light receiver is equal to or less than a threshold, the determination circuitry determines whether the low reflection object or the distant object is present, based on the output of the imager.

8. The imaging device according to claim 1, wherein:
when a charged amount in a pixel by light received by the light receiver is equal to or less than a threshold and the charged amount in a pixel of the imager is equal to or less than the threshold, the determination circuitry determines that the low reflection object is present.

9. The imaging device according to claim 1, wherein:
when a charged amount in a pixel by light received by the light receiver is equal to or less than a threshold, the charged amount in a pixel of the imager is equal to or greater than the threshold, and a distance determined based on the pixel of the imager is equal to or greater than a threshold, the determination circuitry determines that the distant object is present.

10. The imaging device according to claim 1, wherein:
when the determination circuitry detects an edge of an image based on information on the image captured by the imager, and a pixel charged by light received by the light receiver is shifted, the determination circuitry determines that there is an image blur in the captured image.

11. The imaging device according to claim 1, wherein:
distance information to the object is acquired based on the light received by the light receiver.

12. The imaging device according to claim 11, further comprising:
output circuitry configured to output three-dimensional information determined based on the distance information acquired from the light receiver.

13. An imaging processing method, comprising:
imaging an object;
projecting light onto the object;
receiving light reflected from the object;
determining whether a presence or absence of at least one of a high reflection object, a low reflection object, a distant object, or an image blur, based on both the receiving and the imaging; and
displaying according to the presence or absence of at least one of the high reflection object, the low reflection object, the distant object, or the image blur.

14. The imaging processing method according to claim 13, wherein:
the displaying includes displaying a display image, the display image including information on an image captured by the imaging, and identification information for identifying at least one of the high reflection object, the low reflection object, the distant object, and the image blur.

15. An information processing device, comprising:
a display controller configured to
determine whether a presence or absence of at least one of a high reflection object, a low reflection object, a distant object, or an image blur, based on both an output of an imager to capture an image of an object and an output of a light receiver configured to project light onto the object and receive light reflected from the object, and
cause a display to present a different display according to the presence or absence of at least one of the high reflection object, the low reflection object, the distant object, or the image blur, based on the determination result.

16. The information processing device according to claim 15, wherein:
the display controller displays a display image on the display, the display image including information on an image captured by the imager, and identification information for identifying at least one of the high reflection object, the low reflection object, the distant object, and the image blur.
